(19) United States
(12) Patent Application Publication
(10) Pub. No.: US 2025/0276328 A1
(43) Pub. Date: Sep. 4, 2025

(54) MAGNETIC SEPARATION OF PARTICLES SUPPORTED BY SPECIFIC SURFACTANTS

(71) Applicant: BASF SE, Ludwigshafen am Rhein (DE)

(72) Inventors: Oliver KUHN, Rosport (LU); Dieter ETTMUELLER, Ludwigshafen am Rhein (DE); Petra JOHN, Ludwigshafen am Rhein (DE); Wolfgang ROHDE, Ludwigshafen am Rhein (DE)

(21) Appl. No.: 18/279,998

(22) PCT Filed: Mar. 3, 2022
(86) PCT No.: PCT/EP2022/055380

§ 371 Date: Sep. 1, 2023

(30) Foreign Application Priority Data
Mar. 5, 2021 (EP) 21160885.6

(51) Int. Cl. B03C 1/01; B03C 1/28; C22B 3/22; C22B 34/34

(52) U.S. Cl. CPC B03C 1/01; B03C 1/28; C22B 3/22; C22B 34/34; B03C 2201/18

(57) ABSTRACT

The presently claimed invention relates to a process for separation of at least one valuable matter containing material from a dispersion I comprising said at least one valuable matter containing material and at least one second material, wherein the process comprises at least the step (D) of dispersing a magnetic fraction I, which comprises at least one magnetic particle and the at least one valuable matter containing material, in a dispersion medium II, which contains water and a specific surfactant, to obtain a dispersion II, and the step (E) of separating from the dispersion II a non-magnetic fraction II, which comprises the at least one valuable matter containing material.

### FIELD

The present invention relates to a process for separation of at least one valuable matter containing material from a dispersion I comprising said at least one valuable matter containing material and at least one second material, wherein the process comprises at least the step (D) of dispersing a magnetic fraction I, which comprises at least one magnetic particle and the at least one valuable matter containing material, in a dispersion medium II, which contains water and a specific surfactant, to obtain a dispersion II, and the step (E) of separating from the dispersion II a non-magnetic fraction II, which comprises the at least one valuable matter containing material.

### BACKGROUND

Several processes for separation of a desired material from a mixture comprising the said desired material and, in addition, undesired materials are described in the prior art.

WO 2011/064757 A1 relates to a process for separating at least one first material from a mixture comprising this at least one first material and at least one second material using magnetic particles with which the at least one first material agglomerates. The agglomerate comprising the at least one first material and the magnetic particles is treated with a surfactant. However, the surfactants are broadly disclosed.

WO 2016/083491 A1 relates to a process for separation of at least one valuable matter containing material from a dispersion comprising said at least one valuable matter containing material and at least one second material. The use of a biodegradable and/or non-ionic surfactant for cleavage of the agglomerates is disclosed as one of several methods.

The processes for separating a desired valuable matter containing material from a mixture comprising the said desired material and further undesired materials that are disclosed in the prior art can still be improved in respect of the yield of desired valuable matter and/or in respect of the grade of the obtained desired valuable material in agglomerates comprising the desired valuable matter containing material. An improvement in yield or grade of the desired valuable material is obtained by improvement in unloading efficiency of loaded magnetic fractions, i.e., separating the agglomerates of the desired valuable matter containing material and the magnetic particles.

The agglomerates are separated into a non-magnetic fraction without the magnetic particles and a magnetic fraction with the magnetic particles. The whole valuable matter recovery process chain is significantly improved, if this unloading as the last step of a process for separating at least one valuable matter containing material occurs with a high efficiency. High efficiency means a high recovery rate of the at least one valuable matter containing material from the starting agglomerates of the desired valuable matter containing material and the magnetic particles. Accordingly, the desired valuable matter containing material, which is contained in the agglomerates of the desired valuable matter containing material and the magnetic particles, is shifted at the separation towards the non-magnetic fraction. Hence, the magnetic fraction should ideally contain after the unloading no or only a very low amount of the desired valuable matter containing material.

Hence, it is an object according to the presently claimed invention to improve the recovery rate of desired valuable matter containing material from agglomerates of the desired valuable matter containing material and the magnetic particles, which can be performed with low amounts of surfactants and at a high concentration of the desired valuable matter containing material.

### SUMMARY

The object is solved by using specific alkylethoxylates and alkylalkoxyethoxylates to cleave agglomerates of the desired valuable matter containing material and the magnetic particles.

Hence, in one aspect, the presently claimed invention is directed to a process for the separation of at least one valuable matter containing material from a dispersion I comprising said at least one valuable matter containing material and at least one second material, wherein the process comprises the steps of:
(A) providing a dispersion I comprising the at least one valuable matter containing material and the at least one second material;
(B) contacting the dispersion I of step (A) with at least one magnetic particle to obtain a contacted dispersion I;
(C) separating a magnetic fraction I from the contacted dispersion I by applying a magnetic field, wherein the magnetic fraction I comprises the at least one magnetic particle and the at least one valuable matter containing material;
(D) dispersing the magnetic fraction I in at least one dispersion medium II, which contains water and at least one cleavage surfactant, to obtain a dispersion II; and
(E) separating a non-magnetic fraction II from the dispersion II, wherein the non-magnetic fraction II comprises at least one valuable matter containing material;
   wherein the at least one cleavage surfactant is selected from the group consisting of
   (i) alkylethoxylates, which are obtainable by an ethoxylation of R¹—OH with x₁ equivalents of ethylene oxide based on one equivalent R¹—OH, wherein
      R¹ is a branched or linear, unsubstituted C11-C18 alkyl or C11-C18 branched or linear, unsubstituted alkenyl, and
   x₁ is a number larger than or equal to 4.0 and smaller than or equal to 6.5; and
   (ii) alkylalkoxyethoxylates, which are obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, wherein
      R² is a branched or linear, unsubstituted C12-C18 alkyl or a branched or linear, unsubstituted C12-C18 alkenyl,
      x₂ is a number larger than or equal to 4.0 and smaller than or equal to 14.0, and
      y₂ is a number larger than or equal to 1.7 and smaller than or equal to 8.0.

In another aspect, the presently claimed invention is directed to the use of at least one cleavage surfactant for cleaving agglomerates comprising magnetic particles and at least one valuable matter containing material to obtain magnetic particles and at least one valuable matter containing material separately, wherein the at least one cleavage surfactant is selected from the group consisting of
(i) alkylethoxylates, which are obtainable by an ethoxylation of R¹—OH with x₁ equivalents of ethylene oxide based on one equivalent R¹—OH, wherein
   R¹ is a branched or linear, unsubstituted C11-C18 alkyl or branched or linear, unsubstituted C11-C18 alkenyl, and
   x₁ is a number larger than or equal to 4.0 and smaller than or equal to 6.5; and
(ii) alkylalkoxyethoxylates, which are obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, wherein
   R² is a branched or linear, unsubstituted C12-C18 alkyl or branched or linear, unsubstituted C12-C18 alkenyl,
   x₂ is a number larger than or equal to 4.0 and smaller than or equal to 14.0, and
   y₂ is a number larger than or equal to 1.7 and smaller than or equal to 8.0.

### DETAILED DESCRIPTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e. a range of 1 to 10 implies that both 1 and 10 are included in the range. For the avoidance of doubt, the applicant shall be entitled to any equivalents according to applicable law.

One aspect of the presently claimed invention is directed to a process for the separation of at least one valuable matter containing material from a dispersion I comprising said at least one valuable matter containing material and at least one second material, wherein the process comprises the steps of:
(A) providing a dispersion I comprising the at least one valuable matter containing material and the at least one second material;
(B) contacting the dispersion I of step (A) with at least one magnetic particle to obtain a contacted dispersion I;
(C) separating a magnetic fraction I from the contacted dispersion I by applying a magnetic field, wherein the magnetic fraction I comprises the at least one magnetic particle and the at least one valuable matter containing material;
(D) dispersing the magnetic fraction I in at least one dispersion medium II, which contains water and at least one cleavage surfactant, to obtain a dispersion II; and
(E) separating a non-magnetic fraction II from the dispersion II, wherein the non-magnetic fraction II comprises at least one valuable matter containing material;
   wherein the at least one cleavage surfactant is selected from the group consisting of
   (i) alkylethoxylates, which are obtainable by an ethoxylation of R¹—OH with x₁ equivalents of ethylene oxide based on one equivalent R¹—OH, wherein
      R¹ is a branched or linear, unsubstituted C11-C18 alkyl or C11-C18 branched or linear, unsubstituted alkenyl, and
      x₁ is a number larger than or equal to 4.0 and smaller than or equal to 6.5; and
   (ii) alkylalkoxyethoxylates, which are obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, wherein
      R² is a branched or linear, unsubstituted C12-C18 alkyl or a branched or linear, unsubstituted C12-C18 alkenyl,
      x₂ is a number larger than or equal to 4.0 and smaller than or equal to 14.0, and
      y₂ is a number larger than or equal to 1.7 and smaller than or equal to 8.0.

Another aspect of the presently claimed invention is directed to the use of at least one cleavage surfactant for cleaving agglomerates comprising magnetic particles and at least one valuable matter containing material to obtain magnetic particles and at least one valuable matter containing material separately, wherein the at least one cleavage surfactant is selected from the group consisting of
(i) alkylethoxylates, which are obtainable by an ethoxylation of R¹—OH with x₁ equivalents of ethylene oxide based on one equivalent R¹—OH, wherein
   R¹ is a branched or linear, unsubstituted C11-C18 alkyl or branched or linear, unsubstituted C11-C18 alkenyl, and
   x₁ is a number larger than or equal to 4.0 and smaller than or equal to 6.5; and
(ii) alkylalkoxyethoxylates, which are obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, wherein
   R² is a branched or linear, unsubstituted C12-C18 alkyl or branched or linear, unsubstituted C12-C18 alkenyl,
   x₂ is a number larger than or equal to 4.0 and smaller than or equal to 14.0, and
   y₂ is a number larger than or equal to 1.7 and smaller than or equal to 8.0.

The valuable matter may comprise metals or non-metals, for example silicon or carbon in different modifications, also including silicon carbide. The most prominently naturally occurring non-metal valuable is carbon mineralized as graphite or in the form of amorphous coal.

In a preferred embodiment, the at least one valuable matter containing material comprises one or more desired valuable matter, such as metals, in any form. The at least one valuable matter containing material may comprise sulfidic ore minerals, oxidic ore mineral, carbonate comprising ore minerals, metals in elemental form, alloys comprising metals, compounds comprising metals and mixtures thereof.

In another preferred embodiment, the at least one valuable matter containing material comprises metals such as Ag, Au, Pt, Pd, Rh, Ru, Ir, Os, Cu, Mo, Ni, Mn, Zn, Pb, Te, Sn, Hg, Re, V, Fe or mixtures thereof, preferably in the native state or as sulphides, phosphides, selenides, arsenides, tellurides or ore minerals thereof. In a further preferred embodiment, these metals are present in form of alloys such as alloys with other metals such as Fe, Cu, Mo, Ni, Pb, Sb, Bi; with each other, and/or compounds containing non-metals such as phosphides, arsenides, sulphides, selenides, tellurides and the like. The alloys of these metals or their compounds with iron or platinum may for example occur in slags obtained after smelting of spent automotive catalysts.

In a preferred embodiment, the at least one valuable matter containing material comprises Ag, Au, Pt, Pd, Rh, Ru, Ir, Os, Cu, Mo, Ni, Mn, Zn, Pb, Te, Sn, Hg, Re, V, or mixtures thereof; or alloys thereof, preferably with each other and/or with elements like Fe, Ni or Pd.

In a preferred embodiment, the at least one valuable matter is selected from the group consisting of Ag, Au, Pt, Pd, Rh, Ru, Ir, Os, Cu, Mo, Ni, Mn, Zn, Pb, Te, Sn, Hg, Re, V, Fe or combinations or alloys thereof.

In a preferred embodiment, the at least one valuable matter containing material comprises Au, Pt, Ir, Pd, Os, Cu, Mo, Ag, Hg, Rh, Ru or combinations thereof, preferably Au, Pt, Pd or Rh or combinations thereof, and more preferably Pt, Pd or Rh or combinations thereof.

In a preferred embodiment, the at least one valuable matter containing material comprises Ru, Rh, Pd, Os, Cu, Mo, Ir, Pt or combinations or alloys thereof.

In another preferred embodiment, the at least one valuable matter containing material comprises Rh, Pd, Cu, Mo, Pt or combinations or alloys thereof.

In another preferred embodiment, the at least one valuable matter containing material comprises Cu, Mo or a mixture thereof, preferably in the native state or as sulphides, phosphides, selenides, arsenides, tellurides or ore minerals thereof. In a further preferred embodiment, Cu, Mo or a mixture thereof are present in form of alloys such as alloys with other metals such as Fe, Ni, Pb, Sb, Bi; with each other; and/or compounds containing non-metals such as phosphides, arsenides, sulphides, selenides, tellurides and the like.

In a preferred embodiment, the at least one valuable matter is Mo, more preferably molybdenite (MoS₂), or graphite.

In a preferred embodiment, the at least one valuable matter containing material is an ore mineral.

In a preferred embodiment, the at least one valuable matter containing material comprises ore minerals, preferably ore minerals such as sulfidic ore minerals for example molybdenite (MoS₂), chalcopyrite (CuFeS₂), galena (PbS), braggite (Pt,Pd,Ni)S, argentite (Ag₂S) or sphalerite (Zn, Fe)S, oxidic and/or carbonate-comprising ore minerals, for example wulfenite (PbMoO₄) or powellite (CaMoO₄), azurite [Cu₃(CO₃)₂ (OH)₂] or malachite [Cu₂[(OH)₂|CO₃]], rare earth metals comprising ore minerals like bastnaesite (Y, Ce, La)CO₃F, monazite (RE)PO₄ (RE=rare earth metal) or chrysocolla (Cu, Al)₂H₂Si₂O₅ (OH)₄·n H₂O.

In one embodiment, the at least one valuable matter is selected from the group consisting of sulfidic ore minerals such as copper ore minerals comprising covellite CuS, molybdenum (IV) sulfide, chalcopyrite (cupriferous pyrite) CuFeS₂, bornite Cu₅FeS₄, chalcocite (copper glance) Cu₂S and pentlandite (Fe, Ni)₉S₈.

In another preferred embodiment, the at least one valuable matter is a solid solutions of metals such as Pd, Pt, Rh, Au, Ag, Ru, Re in the abovementioned sulfides, and mixtures thereof.

In another preferred embodiment, the at least one valuable matter containing material comprises tellurides and arsenides of metals such as Pd, Pt, Rh, Au, Ag, Ru, Re or other slow-floating precious-metal containing compounds such as Pt—(Pd)—As—S systems like PtAs₂ (sperrylite), Pd₂As (palladoarsenide), PdsAs₃ (stillwaterite), PtAsS (platarsite) or other sulfarsenides like (Pt, Ir, Ru)AsS solid solutions; kotulskite PdTe (and its Bi-rich form); merenskyite PdTe₂ (as well as its intermediate phases in the merenskykite-michenerite solid solutions); michenerite PdBiTe, Pd-bismuthotelluride Pd₈Bi₆Te₃; sopcheite (Pd₃Ag₄Te₄); guanglinite (Pd₃As); palladium arsenide (Pd—As); palladium antimonide (Pd—Sb); paolovite (Pd₂Sn); Pd_{1.6}As_{1.5}Ni, moncheite (Pt, Pd)(Bi, Te)₂; PtTe₂; or PtS (cooperite) and PdS (vysotskite) which may also crystallize from arsenide- or tellu-ride-bearing sulfide melts and thus contain at least some As or Te.

In one preferred embodiment, the at least one valuable matter containing material comprises a valuable matter of platinum group metals (PGM), i.e. Pd, Pt, Rh, Os, Ir or Ru, in an amount of from 0.5 to 50 ppm, more preferably of 0.5 to 4 ppm, and even more preferably of about 1 ppm, relative to the dry weight of the material. In a more preferred embodiment, these PGM metals may be present as solid solution in other sulfidic minerals such as pentlandite. The pentlandite content relative to the dry weight of the valuable matter containing material and at least one second material may, for example, be from 0.1 to 2 wt. % (percent by weight) and preferably from 0.8 to 1.2 wt. %.

In one preferred embodiment, the at least one valuable matter containing material comprises a valuable matter of Mo, Cu or a mixture thereof in an amount of from 10 to 65 wt. %, more preferably of 20 to 55 wt. %, even more preferably 25 to 50 wt. % and very preferably 35 to 45 wt. %, based on the dry weight of the material. In a more preferred embodiment, Mo and Cu may be present at least partly as sulfidic minerals, preferably Mo at least partly as molybdenite (MoS₂), very preferably Mo at least partly as molybdenite (MoS₂) and Cu at least partly as chalcopyrite (CuFeS₂).

In one preferred embodiment, the at least one valuable matter containing material comprises a valuable matter of Mo in an amount of from 5 to 55 wt. %, more preferably of 10 to 50 wt. %, even more preferably 20 to 45 wt. % and very preferably 30 to 40 wt. %, based on the dry weight of the material. In a more preferred embodiment, Mo may be present at least partly as a sulfidic mineral, preferably at least partly as molybdenite (MoS₂).

The at least one second material may be any undesired material. In a preferred embodiment, the at least one second material is a hydrophilic material. In one embodiment, the at least one second material is a hydrophilic metal compound or a hydrophilic semimetal compound. In one embodiment, the at least one second material comprises oxidic metal or semimetal compounds, carbonate comprising metal or semimetal compounds, silicate comprising metal or semimetal compounds, sulfidic metal or semimetal compounds, for example pyrite (FeS₂), hydroxidic metal or semimetal compounds or mixtures thereof. Suitable oxidic metal or semimetal compounds which may be present as the at least one second material according to the invention include, but are not limited to, silicon dioxide (SiO₂), silicates, aluminosilicates, such as feldspars, albite (Na(SisAl)O₈), mica, for example muscovite (KAI₂[(OH,F)₂AlSi₃O₁₀]), garnets (Mg, Ca, Fe^{II})₃(Al, Fe^{III})₂(SiO₄)₃, kaolinite (Al₄[(OH)₈|Si₄O₁₀), pyrophyllite (Al₂[(OH)₂|Si₄O₁₀), quartz (SiO₂), illite (K_{0.65}Al_{2.0}Al_{0.65}Si_{3.35}O₁₀(OH)₂) and further related minerals and mixtures thereof.

In one preferred embodiment, the at least one second material is selected from the group consisting of SiO₂, CaO, Al₂O₃, MgO, ZrO₂, Fe₂O₃, Fe₃O₄, CeO₂, Cr₂O₃, complex oxide matrices and mixtures thereof.

In a preferred embodiment, the at least one second material comprises chromium or chromium-containing compounds or minerals or mixtures thereof.

Accordingly, in a preferred embodiment, the dispersion I comprising the at least one valuable matter containing material and the at least one second material may comprise untreated ore and/or ore mineral mixtures obtained from mines.

The individual essential and optional steps of the process according to the presently claimed invention are explained in detail in the following. Each single step and/or the whole process of the present invention may be conducted continuously or discontinuously, wherein conducting each single step and the whole process continuously is preferred.

### Step (A):

Step (A) of the process according to the presently claimed invention comprises providing a first dispersion I comprising a dispersion medium I comprising the at least one valuable matter containing material and at least one second material.

Suitable dispersion mediums according to the presently claimed invention are water or lower alcohols, such as C1-C4 alcohols.

In a preferred embodiment, the dispersion medium I is a non-flammable solvent, such as water.

In a further embodiment according to the presently claimed invention, the first dispersion I comprising a dispersion medium I and at least one valuable matter containing material and at least one second material comprises slag, for example smelter slag or furnace slag. These materials are in general known to the skilled artisan. In a preferred embodiment, the slag may be furnace slag resulting from processing concentrates from platinum group metals (PGMs) bearing ores, spent catalyst materials or mixtures thereof.

In a preferred embodiment, the first dispersion I comprises slag, and preferably furnace slag, which is obtained from smelting processes known to the skilled artisan, for example smelting processes to obtain metals such as Mo, Cu, Ni, Ag, Hg, Au, Pt, Pd, Rh, Ru, Ir, Os or mixtures thereof.

In a preferred embodiment, the first dispersion I comprising a dispersion medium I, at least one valuable matter containing material and at least one second material comprises furnace slag. Said furnace slag may be obtained as a product, for example an end-product, aby-product and/or as a waste-product of smelting processes.

In a preferred embodiment, the first dispersion I comprising a dispersion medium I, at least one valuable matter containing material and at least one second material comprises smelter slag, wherein preferably the smelter slag is obtained from the mixing layer.

In a preferred embodiment, the first dispersion I comprising a dispersion medium I, at least one valuable matter containing material and at least one second material comprises artificially prepared slag.

In a preferred embodiment, the first dispersion I comprising a dispersion medium I, at least one valuable matter containing material and at least one second material comprises furnace slag comprising at least one valuable matter and from 5 to 80% by weight SiO2, from 20 to 50% by weight CaO, from 0 to 60% by weight Al₂O₃, from 0 to 10% by weight MgO, from 0 to 10% by weight P₂O₅, from 0 to 10% by weight ZrO₂, from 0 to 10% by weight Fe₂O₃, and optionally other iron oxides, from 0 to 10% by weight CeO₂, and optionally other components, wherein the % are based on the total weight of the furnace slag.

In another preferred embodiment, the first dispersion I comprising a dispersion medium I, the at least one valuable matter containing material and at least one second material comprises slag which may contain further components such as lead- and/or iron-containing compounds and/or lead and/or iron in metallic form. In a preferred embodiment, iron containing compounds like magnetite are present in the slag to be separated.

In another preferred embodiment, the first dispersion I comprising a dispersion medium I, at least one valuable matter containing material and at least one second material comprises slag containing at least one valuable matter in an amount of from 0.01 to 1000 g/t or from 0.01 to 500 g/t slag.

According to a particularly preferred embodiment of to the presently claimed invention, the first dispersion I comprises slag comprising at least one valuable matter selected from Ag, Au, Pt, Pd, Rh, Ru, Ir, Os, Zn, Pb, Te, Sn, Hg, Re or V/or the base metals sulfides of Cu, Mo, Ni and Mn or others in an amount of from 0.01 to 1000 g/t slag.

In a preferred embodiment, the first dispersion I comprising a dispersion medium I, at least one valuable matter containing material and at least one second material comprises ore-bearing slag and/or wet ore tailings.

In a preferred embodiment, the first dispersion I comprises at least one valuable matter containing material and at least one second material in the form of particles, preferably particles having a particles size of from 100 nm to 400 μm. Such particles may be prepared as shown in U.S. Pat. No. 5,051,199. In a preferred embodiment, the particle size is obtained by comminuting, for example by milling. Suitable processes and apparatuses for comminuting are known to those skilled in the art and examples thereof include wet milling in a ball mill. In a preferred embodiment, the dispersion comprising at least one valuable matter containing material and the at least one second material is therefore comminuted, preferably milled, to particles, preferably particles having a particles size of from 100 nm to 400 μm before or during step (A). Analytical methods for determining the particle size are known to the skilled artisan and for example include Laser Diffraction or Dynamic Light Scattering for particle sizes of 100 nm to 400 μm or sieve analysis for particles having particle sizes from about 10 μm to several millimeters. Preferably, the particle size is an average particle size. More preferably, the average particle size is stated as d₈₀. Very preferably, the average particle size of the particles of the at least one valuable matter containing material and at least one second material has a d₈₀ between 1 μm and 400 μm, particularly a d₈₀ between 4 and 200 μm, very particularly a d₈₀ between 10 and 100 μm and especially a d₈₀ between 20 and 50 μm.

In a preferred embodiment according to the presently claimed invention, at least one milling additive may be added before or during the milling of the at least one valuable matter containing material and the at least one second material. The at least one milling additive is preferably added in an amount of from 5 g/t to 10000 g/t, based on the weight of the material to be milled. Examples of suitable milling additives include organic polymers that may be used as clay dispersants. Said polymers may additionally decrease slurry viscosities during milling and thus decrease the energy costs of the milling step, or even increase the grade of the separated valuable matter containing material. Examples of such commercially available polymers include carboxymethyl celluloses, such as carboxymethyl celluloses in neutral or neutralized form. Examples also include the Anti-Prex® product line of BASF SE.

In a preferred embodiment, the at least one valuable matter containing material is present in the form of particles.

In a preferred embodiment, comminuting is conducted during step (A).

### Step (B):

Step (B) of the process according to the presently claimed invention comprises contacting the dispersion I of step (A) with at least one magnetic particle, preferably in a manner that the at least one valuable matter containing material and the at least one magnetic particle become attached to one another and form at least one magnetic agglomerate. The agglomeration between the at least one valuable matter containing material and the at least one magnetic particle may generally occur as a result of all attractive forces known to those skilled in the art, for example as a result of hydrophobic interactions and/or magnetic forces. Preferably, only the at least one valuable matter containing material and the at least one magnetic particle agglomerate in step (A) while the at least one second material and the at least one magnetic particle do not agglomerate.

In a preferred embodiment, the at least one valuable matter containing material and the at least one magnetic particle agglomerate due to hydrophobic interactions or different surface charges. The agglomeration may be at least partly due to the treatment of the at least one valuable matter containing material and/or magnetic particle with a surface-modifying agent. For example, the international publications WO 2009/010422 A1, WO 2009/065802 A2, WO 2010/007075 A1 and WO 2010/007157 A1 disclose surface-modifying agents which selectively couple the at least one valuable matter containing material and the at least one magnetic particle.

In a preferred embodiment, the at least one valuable matter containing material and the at least one magnetic particle agglomerate as a result of hydrophobic interactions.

In a preferred embodiment, the at least one valuable matter containing material has been pre-treated with at least one collector before step (A), in step (A) and/or in step (B) of the process according to the presently claimed invention.

In a preferred embodiment, the at least one collector is added to the dispersion I in step (A) or in step (B) or the at least one valuable matter containing material has been pre-treated with at least one collector.

In a preferred embodiment, the contact angle between the particle comprising the at least one valuable matter containing material treated with the at least one collector and water against air is >90°. Methods to determine the contact angle are well known to the skilled artisan. For example, the contact angle against water is determined by optical drop shape analysis, e.g. using a DSA 100 contact angle measuring device of Kruesse (Hamburg, Germany) with the respective software. Typically, 5 to 10 independent measurements are performed in order to determine are liable average contact angle. Thus, the treatment with the at least one collector renders the at least one valuable matter containing material hydrophobic.

In a preferred embodiment, the at least one valuable matter containing material has been pre-treated with at least collector selected from the group consisting of non-ionizing collectors and ionizing collectors.

In a preferred embodiment, the non-ionizing collector can be a molecule with hydrophilic moieties and lipophilic moieties, i.e. a polar non-ionizing collector. Examples of polar non-ionizing collectors are non-ionic surfactants.

In a preferred embodiment, the non-ionizing collector can also be a non-polar molecule, i.e. a molecule with essentially only lipophilic moieties. Examples of non-polar non-ionizing collectors are diesel and Shellsol® D40 listed at the experimental part at section A). Preferably, a non-polar non-ionizing collector is a mineral oil, a vegetable oil, biodiesel, a product of coal liquefaction, a product of gas-to-liquid process and mixtures thereof. A non-polar non-ionizing collector also includes a mixture of non-polar non-ionizing collectors, for example a mineral oil is typically a mixture of different hydrocarbon molecules. A non-polar non-ionizing collector, which can be used in the process as a collector generally has a low viscosity under the conditions of the process, so that it is liquid and mobile under the conditions of the process. Preference is given to using a non-polar non-ionizing collector, which has a kinematic viscosity at 20° C. in a range from 0.7 to 25 mm²/s, preferably from 0.9 to 20 mm²/s, more preferably from 1 to 15 mm²/s and very preferably from 1.1 to 10 mm²/s. Furthermore, preference is given to using anon-polar non-ionizing collector, which has a flash point of larger than or equal to 20° C., preferably larger than or equal to 40° C.

A mineral oil is for example a crude oil derivative, a crude oil itself or an oil produced from brown coal, hard coal, peat or wood. A mineral oil typically comprises hydrocarbon mixtures of paraffinic hydrocarbons, i.e. saturated chain-like hydrocarbons, naphthenic hydrocarbons, i.e. saturated cyclic hydrocarbons, and aromatic hydrocarbons. A particularly preferred crude oil derivative is diesel, gas oil or kerosene. Diesel is based essentially on mineral oil, i.e. diesel is a fraction in the fractionation of mineral oil by distillation. The main constituents of diesel are predominantly alkanes, cycloalkanes and aromatic hydrocarbons having from about 9 to 22 carbon atoms per molecule and a boiling range from 170 to 390° C. Gas oil is for example light gas oil with a boiling range of 235 to 300° C. or heavy gas oil with a boiling range of 300 to 375° C. A vegetable oil are generally fats and fatty oils which are obtained from oil plants. A vegetable oils comprises, for example, triglycerides. A vegetable oil is for example selected from the group consisting of sun-flower oil, rapeseed oil, safflower oil, soybean oil, corn oil, peanut oil, olive oil, herring oil, cotton seed oil, palm oil and mixtures thereof. A biodiesel comprises essentially methyl esters of saturated C16-C18 fatty acids and unsaturated C18 fatty acids, in particular the methyl ester of rapeseed oil. A product of coal liquefaction is for example obtained by the Fischer-Tropsch or Sasol process.

An anionic collector is a molecule which contains a lipophilic moiety and an anionic group. An anionic group herein means that at a pH of 7 the majority of the anionic groups is negatively charged if one looks at a larger number of molecules. An example of an anionic group, named in the following as its deprotonated form, is a sulfide, a xanthate, a thioxanthate, a dithiocarbamate, a carboxylate, a hydroxamate, a phosphate, a thiophosphate, a dithiophosphate, a trithiophosphate, a tetrathiophosphate, a phosphinate, a thiophosphinate, a dithiophosphinate, a sulfonate or a sulfate group. An anionic collector can also contain more than one anionic group, e.g. two as in the case of a sulfosuccinate. The lipophilic moiety is typically a branched or linear C4-C18 alkyl or alkenyl. For example, n-octyl or a branched C6-C14 alkyl, wherein the branch is preferably located in 2-position, for example 2-ethylhexyl or 2-propylheptyl. An anionic collector can also contain more than one lipophilic moiety, for example two like at a dialkyl phosphate.

In a preferred embodiment, the at least one collector is an anionic collector selected from the group consisting of sodium- or potassium n-octylxanthate, sodium- or potassium butylxanthate, sodium- or potassium di-n-octyldithiophosphinate, sodium- or potassium di-n-octyldithiophosphate, sodium- or potassium di-n-octyldithiocarbamates, sodium or potassium ethyl-hexylxanthate and mixtures thereof. In a particularly preferred embodiment, the at least one collector is an anionic collector and selected from the group consisting of potassium-n-octyl xanthate (1:1 salt of carbonodithionic acid O-octyl ester) or potassium di-n-octyldithiophosphinate or mixtures thereof.

A cationic collector is a molecule which contains a lipophilic moiety and a cationic group. A cationic group herein means that at a pH of 7 the majority of the cationic groups is positively charged if one looks at a larger number of molecules, either by protonation or because of a permanent cationic charge, for example a quaternary nitrogen. An example of a cationic group, named in the following as its deprotonated form, is a primary amine, a secondary amine, a tertiary amine or a quaternary amine. A cationic collector can also contain more than one cationic group, for example two like at alkyl ether diamines. The lipophilic moiety is typically a branched or linear C4-C18 alkyl or alkenyl. For example, n-octyl or a branched C6-C14 alkyl, wherein the branch is preferably located in 2-position, for example 2-ethylhexyl or 2-propylheptyl. A cationic collector can also contain more than one lipophilic moiety, for example two like at a dialkyl amine.

An amphoteric collector is a molecule which contains a lipophilic moiety, an anionic group and a cationic group. The examples at the two previous paragraphs apply similarly for the lipophilic moiety, the anionic group and the cationic group. An example for an amphoteric collector is 8-hydroxyquinoline with its close proximity and sterically same direction of a phenolate group and a pyridine group opposite to the lipophilic moiety built by the aromatic CH-units.

Non-limiting examples of collectors are also found in the “Collector Handbook of Floating Agents: Chemistry, Theory and Practice, Srdjan M. Balutovic, February 2008, Elsevier.”

In a preferred embodiment, a collector for a valuable matter containing material, wherein the at least one valuable matter is a noble metal, such as Au, Pd, Rh, Cu, Mo, etc., is a monothiol, a dithiol, a trithiol or 8-hydroxyquinoline.

In another preferred embodiment, a collector for a valuable matter containing material, wherein the at least one valuable matter is a metal sulfide, such as Cu₂S, MoS₂ etc., is a monothiol, a dithiol and a trithiol, a xanthate or a dithiophosphate.

In a preferred embodiment, the at least one collector is used in an amount which is sufficient to achieve the desired effect. In a preferred embodiment, the at least one collector is added in an amount of from 0.001 to 4 wt. % based on the weight of the dry at least one valuable matter containing material and the at least one second material. Preferably, the amount is from 0.001 to about 3 wt. %. In case of a non-polar non-ionizing collector, the amounts are higher in comparison to a polar non-ionizing collector, an anionic collector, a cationic collector or an amphoteric collector.

In general, the at least one magnetic particle in step (B) of the process according to the presently claimed invention may be any magnetic particle.

In a preferred embodiment, the at least one magnetic particle is selected from the group consisting of magnetic metals, preferably irons, cobalt, nickel and mixtures thereof; ferromagnetic alloys of magnetic metals, for example NdFeB, SmCo and mixtures thereof; magnetic iron oxides, for example magnetite, magnetic hematite, hexagonal ferrites; cubic ferrites of the general formula (M-I):

M2+mFe2+1−mFe3+2O4 (M-I)
wherein M is selected from Co, Ni, Mn, Zn or mixtures thereof and m is ≤1, and mixtures thereof.

In a particularly preferred embodiment, the at least one magnetic particle is magnetite. Magnetite is known to the skilled artisan and is commercially available, e.g. as magnetic pigment 345 (BASF SE) or magnetite from Höganäs. Furthermore, processes for the preparation of magnetite are known to those skilled in the art.

In a preferred embodiment, the at least one magnetic particle is selected from the group consisting of magnetic metals and mixtures thereof, ferromagnetic alloys of magnetic metals and mixtures thereof, magnetic iron oxides, cubic ferrites of general formula M-I:

M2+mFe2+1−mFe3+2O4 (M-I)
wherein M is selected from Co, Ni, Mn, Zn or mixtures thereof and m is ≤1, hexagonal ferrites and mixtures thereof.

The at least one magnetic particle that is used in accordance with the presently claimed invention has in general an average diameter that enables this particle to efficiently agglomerate with the at least one valuable matter containing material. In a preferred embodiment, the magnetic particle has a d₈₀ of from 1 nm to 10 mm, preferably of from 0.1 μm to 100 μm and very preferably from 1 μm to 20 μm. The wording “d₈₀” is known the skilled artisan and means that 80 wt. % of the corresponding particles have a diameter that is smaller than or equal to the mentioned value. The particle size of the magnetite can be reduced prior use by grinding or milling. Methods for analyzing the diameter of the magnetic particles or other particles that are used or treated according to the presently claimed invention are known to the skilled artisan. Such methods for example include Laser Diffraction Measurement, in particular Laser Diffraction Measurement using a Mastersizer 2000 with software version 5.12G, wherein the sample is dispersed in an aqueous solution of Na₄P₂O₇.

In general, the amount of at least one magnetic particle to be applied in the process of the presently claimed invention can be determined by a person having ordinary skill in the art in a way that advantageously the whole amount of the at least one valuable matter containing material can be separated by agglomerating with the at least one magnetic particle. In a preferred embodiment of the process according to the presently claimed invention, the at least one magnetic particle is added in an amount of from 0.01 to 10 wt. %, preferably from 0.1 to 6 wt. %, particularly preferably from 0.5 to 4.5 wt. %, based on the weight of the dry at least one valuable matter containing material and the at least one second material.

In one preferred embodiment, the at least one magnetic particle is a hydrophobic magnetic particle. In a preferred embodiment, the at least one magnetic particle is hydrophobized on its surface, i.e. is a hydrophobized magnetic particle. In a more preferred embodiment, the at least one magnetic particle has been hydrophobized by treatment with a hydrophobizing agent, wherein preferably the magnetic particle treated with the hydrophobizing agent has a contact angle between the particle surface and water against air of preferably more than 30°, more preferably more than 60°, even more preferably more than 90° and particularly preferably more than 140°. Methods to determine the contact angle are well known to the skilled artisan. For example, the contact angle against water is determined by optical drop shape analysis, e.g. using a DSA 100 contact angle measuring device of Kruesse (Hamburg, Germany) with the respective software. Typically, 5 to 10 independent measurements are performed in order to determine a reliable average contact angle. In general, the hydrophobizing agent may be any agent that will render the surface of the magnetic particle more hydrophobic than the surface of the magnetic particle before the treatment.

In a preferred embodiment, the hydrophobizing agent for hydrophobizing the at least one magnetic particle is a compound of the general formula (I-H) or derivative thereof:

[(B)e—(Y)f]g (H-I),
Wherein, each B is independently selected from among branched or linear C1-C30 alkyl, C1-C30 heteroalkyl, optionally substituted C6-C30 aryl, optionally substituted C6-C30 heteroalkyl, C6-C30 aralkyl;
each Y is independently selected as a group by means of which the compound of the general formula (H—I) binds to the at least one magnetic particle;
each e is the integer 1, 2, 3, 4, 5, 6, 7, 8, 9 or 10;
each f is the integer 1, 2, 3, 4, 5, 6, 7, 8, 9 or 10; and
each g is the integer 1, 2, 3, 4, 5, 6, 7, 8, 9 or 10 to 100.

In a particularly preferred embodiment, B is a branched or linear C6-C18 alkyl, preferably linear C8-C12 alkyl and very particularly preferably a linear C12 alkyl.

In a further particularly preferred embodiment, Y is selected from the group consisting of —(X)ₚ—Si(R²⁰)₃, —(X)ₚ—SiH(R²⁰)₂, —(X)ₚSiH₂R²⁰, wherein each R²⁰ is independently selected from F, Cl, Br, I or OH; and anionic groups such as

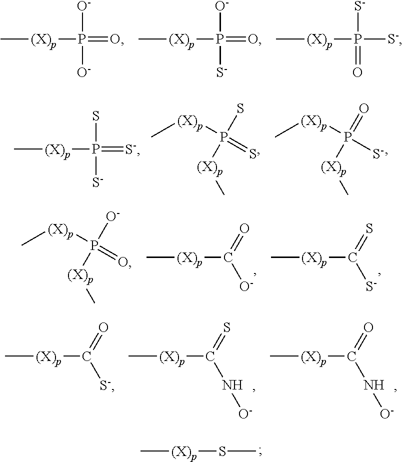

wherein each X is independently O, S, NH, or CH₂ and p is 0, 1 or 2.

Very particularly preferred hydrophobizing agents of the general formula (H—I) are silicon-based oils or siloxanes resulting from in-situ hydrolysis of dodecyl- or other alkyltrichlorosilanes or alkyltrialkoxysilanes; phosphonic acids, for example octylphosphonic acid; carboxylic acids; for example lauric acid, oleic acid or stearic acid; partly polymerized siloxanes (also known as silicon oils), or mixtures thereof.

In a preferred embodiment, the hydrophobizing agent is a compound as disclosed in WO 2012/140065.

Further preferred hydrophobizing agents are mono-, oligo- or polysiloxanes with free OH groups, such as the compounds of formulae H-Ia, H-Ib or H-Ic or derivatives thereof

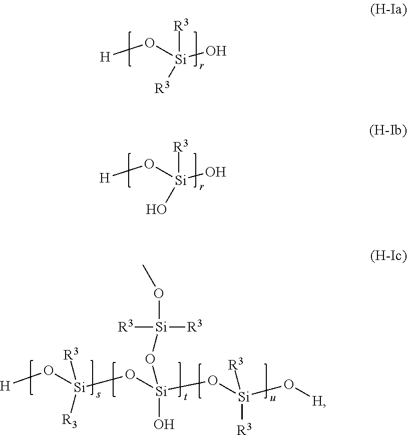

wherein each r, s, t, and u is independently an integer from 1 to 100, and each R³ is independently a branched or linear C1-C12 alkyl group.

In formula (H-Ic),* denotes a bonding to further moieties comprising —SiOR⁴ and wherein R⁴ is selected from hydrogen, branched or linear, optionally substituted C1-C30 alkyl, branched or linear, optionally substituted C2-C30 alkenyl, branched or linear, optionally substituted C2-C30 alkynyl, optionally substituted C3-C20 cycloalkyl, optionally substituted C3-C20 cycloalkenyl, optionally substituted C1-C20 heteroalkyl, optionally substituted C5-C22 aryl, optionally substituted C6-C23 alkylaryl, optionally substituted C6-C23 arylalkyl or optionally substituted C5-C22 heteroaryl.

In a preferred embodiment, the hydrophobizing agents of formulae H-la, H-Ib or H-Ic have a molecular weight from 250 to 200000 g/mol, preferably from 250 to 20000 g/mol and particularly preferably from 300 to 5000 g/mol.

According to a preferred embodiment, the hydrophobizing agent is a compound of the general formulae H-II, H-IIa, H-IIb or H-IIIc or derivatives thereof

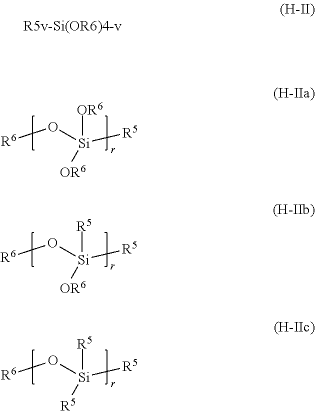

wherein each R⁵ is independently selected from hydrogen, branched or linear, optionally substituted C1-C30 alkyl, branched or linear, optionally substituted C2-C30 alkenyl, branched or linear, optionally substituted C2-C30 alkynyl, optionally substituted C3-C20 cycloalkyl, optionally substituted C3-C20 cycloalkenyl, optionally substituted C1-C20 heteroalkyl, optionally substituted C5-C22 aryl, optionally substituted C6-C23 alkylaryl, optionally substituted C6-C23 arylalkyl or optionally substituted C5-C22 heteroaryl;
each R⁶ is independently selected from hydrogen, branched or linear, optionally substituted C1-C30 alkyl, branched or linear, optionally substituted C2-C30 alkenyl, branched or linear, optionally substituted C2-C30-alkynyl, optionally substituted C3-C20 cycloalkyl, optionally substituted C3-C20 cycloalkenyl, optionally substituted C1-C20 heteroalkyl, optionally substituted C5-C22 aryl, optionally substituted C6-C23 alkylaryl, optionally substituted C6-C23 arylalkyl or optionally substituted C5-C22 heteroaryl;
r is independently an integer from 1 to 100 and vis 1, 2 or 3.

Preference is given to the radicals R⁵ each being, independently of one another, branched or linear, optionally substituted C1-C30 alkyl, particularly preferably C1-C20 alkyl, very particularly preferably C4-C12 alkyl. In a preferred embodiment, R⁵ is branched or linear, unsubstituted C1-C30 alkyl, particularly preferably C1-C20 alkyl or very particularly preferably C4-C12 alkyl. Examples of branched or linear C4-C12 alkyl radicals are butyl, in particular, n-butyl, isobutyl, tert-butyl; pentyl, in particular n-pentyl, isopentyl, tert-pentyl; hexyl, in particular n-hexyl, isohexyl, tert-hexyl, heptyl; in particular n-heptyl, isoheptyl, tert-heptyl; octyl in particular n-octyl, isooctyl, tert-octyl; nonyl, in particular n-nonyl, isononyl, tert-nonyl, decyl, in particular n-decyl, isodecyl, tert-decyl, undecyl, in particular n-undecyl, isoundecyl, tert-undecyl, or dodecyl, in particular n-dodecyl; iso-dodecyl or tert-dodecyl.

Further preference is given to the radicals R⁵ each being, independently of one another, branched or linear, optionally substituted C2-C30 alkenyl, particularly preferably C2-C20 alkenyl, very particularly preferably or C2-C12 alkenyl. Examples of alkenyl radicals which are particularly preferred according to the invention are ethenyl (vinyl), propenyl, in particular n-propenyl, isopropenyl, butenyl, in particular n-butenyl, isobutenyl, tert-butenyl, pentenyl, in particular n-pentenyl, isopentenyl, tert-pentenyl, hexenyl, in particular n-hexenyl, isohexenyl, tert-hexenyl, heptenyl, in particular n-heptenyl, isoheptenyl, tert-heptenyl, octenyl, in particular n-octenyl, isooctenyl, tert-octenyl, nonenyl, in particular n-nonenyl, isononenyl, tert-nonenyl, decenyl, in particular n-decenyl, isodecenyl, tert-decenyl, undecenyl, in particular n-undecenyl, isoundecenyl, tert-undecenyl, or dodecenyl, in particular n-dodecenyl, isododecenyl and tert-dodecenyl.

Further preference is given to the radicals R⁵ each being, independently of one another, branched or linear, optionally substituted C2-C30 alkynyl, particularly preferably C2-C20 alkynyl, very particularly preferably C2-C12 alkynyl. Examples of alkynyl radicals which are particularly preferred according to the invention are ethynyl, propynyl, in particular n-propynyl, isopropynyl, butynyl, in particular n-butynyl, isobutynyl, tert-butynyl, pentynyl, in particular n-pentynyl, isopentynyl, tert-pentynyl, hexynyl, in particular n-hexynyl, isohexynyl, tert-hexynyl, heptynyl, in particular n-heptynyl, isoheptynyl, tert-heptynyl, octynyl, in particular n-octynyl, isooctynyl, tert-octynyl, nonynyl, in particular n-nonynyl, isononynyl, tert-nonynyl, decynyl, in particular n-decynyl, isodecynyl, tert-decynyl, undecynyl, in particular n-undecynyl, isoundecynyl, tert-undecynyl, or dodecynyl, in particular n-dodecynyl, isododecynyl and tert-dodecynyl.

Further preference is given to the radicals R⁵ each being, independently of one another, optionally substituted C3-C20 cycloalkyl, particularly preferably C3-C12 cycloalkyl, very particularly preferably C3-C6 cycloalkyl, such as cyclopropyl, cyclobutyl, cyclopentyl or cyclohexyl.

Further preference is given to the radicals R⁵ each being, independently of one another, optionally substituted C3-C20 cycloalkenyl, particularly preferably C3-C12 cycloalkenyl, very particularly preferably C3-C6 cycloalkenyl such as cyclopropenyl, cyclobutenyl, cyclopentenyl or cyclohex-enyl.

Further preference is given to the radicals R⁵ each being, independently of one another, optionally substituted C1-C20 heteroalkyl, particularly preferably C1-C12 heteroalkyl. The heteroalkyl radicals present according to the invention are derived from the abovementioned alkyl radicals, with at least one carbon atom being replaced by a heteroatom selected from among N, O, P and S.

Further preference is given to the radicals R⁵ each being, independently of one another, optionally substituted C5-C22 aryl, particularly preferably C5-C12 aryl. Examples of aryl radicals which are preferred according to the invention are phenyl, naphthyl or biaryls.

Further preference is given to the radicals R⁵ each being, independently of one another, optionally substituted C6-C23 alkylaryl, particularly preferably C6-C13 alkylaryl. An example of an alkylaryl radical which is preferred according to the invention is benzyl.

Further preference is given to the radicals R⁵ each being, independently of one another, optionally substituted C6-C23 arylalkyl, particularly preferably C6-C13 arylalkyl. Examples of arylalkyl radicals which are preferred according to the invention are tolyl, xylyl, propylbenzyl or hexylbenzyl.

The abovementioned radicals R⁵ can optionally be substituted. Suitable substituents are, for example, selected from among amino, amido, imido, hydroxyl, ether, aldehyde, keto, carboxylic acid, thiol, thioether, hydroxamate and carbamate groups. The abovementioned radicals R⁵ can be mono- or poly-substituted. In the case of multiple substitutions, one substituent group can be present a plurality of times or various functional groups are simultaneously present. The radicals mentioned for R⁵ can also be mono- or poly-substituted by the abovementioned alkyl, alkenyl, alkynyl, aryl, alkylaryl, arylalkyl, heteroalkyl or heteroaryl radicals.

Very particularly preferred radicals R⁵ are octyl, in particular n-octyl; hexyl, in particular n-hexyl; and/or butyl, in particular n-butyl; decyl, in particular n-decyl; or dodecyl, in particular n-dodecyl.

Preference is given to the radicals R⁶ each being, independently of one another, hydrogen, branched or linear, optionally substituted C1-C30 alkyl, particularly preferably C1-C20 alkyl, very particularly preferably C1-C12 alkyl. In a preferred embodiment, R⁶ is branched or linear, unsubstituted C1-C30 alkyl, particularly preferably C1-C20 alkyl, or very particularly preferably C1-C12 alkyl. Examples of branched or linear C1-C12 alkyl radicals are methyl, ethyl, propyl, in particular n-propyl, isopropyl, butyl, in particular n-butyl, isobutyl, tert-butyl, pentyl, in particular n-pentyl, isopentyl, tert-pentyl, hexyl, in particular n-hexyl, isohexyl, tert-hexyl, heptyl, in particular n-heptyl, isoheptyl, tert-heptyl, octyl, in particular n-octyl, isooctyl, tert-octyl, nonyl, in particular n-nonyl, isononyl, tert-nonyl, decyl, in particular n-decyl, isodecyl, tert-decyl, undecyl, in particular n-undecyl, isoundecyl, tert-undecyl, or dodecyl, in particular n-dodecyl, isododecyl or tert-dodecyl.

Further preference is given to the radicals R⁶ each being, independently of one another, branched or linear, optionally substituted C2-C30 alkenyl, particularly preferably C2-C20 alkenyl and very particularly preferably C2-C12 alkenyl. Examples of alkynyl radicals which are particularly preferred according to the invention are ethenyl (vinyl), propenyl, in particular n-propenyl, isopropenyl, butenyl, in particular n-butenyl, isobutenyl, tert-butenyl, pentenyl, in particular n-pentenyl, isopentenyl, tert-pentenyl, hexenyl, in particular n-hexenyl, isohexenyl, tert-hexenyl, heptenyl, in particular n-heptenyl, isoheptenyl, tert-heptenyl, octenyl, in particular n-octenyl, isooctenyl, tert-octenyl, nonenyl, in particular n-nonenyl, isononenyl, tert-nonenyl, decenyl, in particular n-decenyl, isodecenyl, tert-decenyl, undecenyl, in particular n-undecenyl, isoundecenyl, tert-undecenyl, or dodecenyl, in particular n-dodecenyl, isododecenyl or tert-dodecenyl.

Further preference is given to the radicals R⁶ each being, independently of one another, branched or linear, optionally substituted C2-C30 alkynyl, particularly preferably C2-C20 alkynyl or very particularly preferably C2-C12 alkynyl. Examples of alkynyl radicals which are particularly preferred according to the invention are ethynyl, propynyl, in particular n-propynyl, isopropynyl, butynyl, in particular n-butynyl, isobutynyl, tert-butynyl, pentynyl, in particular n-pentynyl, isopentynyl, tert-pentynyl, hexynyl, in particular n-hexynyl, isohexynyl, tert-hexynyl, heptynyl, in particular n-heptynyl, isoheptynyl, tert-heptynyl, octynyl, in particular n-octynyl, isooctynyl, tert-octynyl, nonynyl, in particular n-nonynyl, isononynyl, tert-nonynyl, decynyl, in particular n-decynyl, isodecynyl, tert-decynyl, undecynyl, in particular n-undecynyl, isoundecynyl, tert-undecynyl, or dodecynyl, in particular n-dodecynyl, isododecynyl or tert-dodecynyl.

Further preference is given to the radicals R⁶ each being, independently of one another, optionally substituted C3-C20 cycloalkyl, particularly preferably C3-C12 cycloalkyl and particularly preferably C3-C6 cycloalkyl, for example cyclopropyl, cyclobutyl, cyclopentyl or cyclohexyl.

Further preference is given to the radicals R⁶ each being, independently of one another, optionally substituted C3-C20 cycloalkenyl, particularly preferably C3-C12 cycloalkenyl and very particularly preferably C3-C6 cycloalkenyl, for example cyclopropenyl, cyclobutenyl, cyclopentenyl or cyclo-hexenyl.

Further preference is given to the radicals R⁶ each being, independently of one another, optionally substituted C1-C20 heteroalkyl, particularly preferably C4-C12 heteroalkyl. The heteroalkyl radicals which are present according to the invention are derived from the abovementioned alkyl radicals, with at least one carbon atom being replaced by a heteroatom selected from among N, O, P and S.

Further preference is given to the radicals R⁶ each being, independently of one another, optionally substituted C5-C22 aryl, particularly preferably C5-C12 aryl. Examples of aryl radicals which are preferred according to the invention are phenyl, naphthyl or biaryls.

Further preference is given to the radicals R⁶ each being, independently of one another, optionally substituted C6-C23 alkylaryl, particularly preferably C6-C13 alkylaryl. An example of an alkylaryl radical which is preferred according to the invention is benzyl.

Further preference is given to the radicals R⁶ each being, independently of one another, optionally substituted C5-C22 heteroaryl and particularly preferably C5-C12 heteroaryl.

The abovementioned radicals R⁶ may optionally be substituted. Suitable substituents are, for example, selected from among amino, amido, imido, hydroxy, ether, aldehyde, keto, carboxylic acid, thiol, thioether, hydroxamate and carbamate groups. The abovementioned radicals R⁶ can be mono- or poly-substituted. In the case of multiple substitutions, one substituent can be present a plurality of times or various functional groups are simultaneously present. The radicals mentioned for R⁶ can also be mono- or poly substituted by the abovementioned alkyl, alkenyl, alkynyl, aryl, alkylaryl, arylalkyl, heteroalkyl or heteroaryl radicals.

In another preferred embodiment, the at least one hydrophobizing agent is selected from the group consisting of (NaO)(CH₃)Si(OH)₂, (NaO)(C₂H₅) Si(OH)₂, (NaO)(C₅H₁₁)Si(OH)₂, (NaO)(C₈H₁₇)Si(OH)₂, (KO)(CH₃)Si(OH)₂, (KO)(C₂H₅)Si(OH)₂, (KO)(C₅H₁₁) Si(OH)₂, (KO) (C₈H₁₇)Si(OH)₂, (NH₄O)(CH₃)Si(OH)₂, (NH₄O)(C₂H₅)Si(OH)₂, (NH₄O)(C₅H₁₁)Si(OH)₂, (NH₄O)(C₈H₁₇)Si(OH)₂, (NaO)₂(CH₃) Si(OH), (NaO)₂(C₂H₅)Si(OH), (NaO)₂(C₅H₁₁)Si(OH), (NaO)₂(C₈H₁₇)Si(OH), (KO)₂(CH₃)Si(OH), (KO)₂(C₂H₅)Si(OH), (KO)₂ (C₅H₁₁)Si(OH), (KO)₂(C₈H₁₇)Si(OH), (NH₄O)₂(CH₃)Si(OH), (NH₄O)₂(C₂H₅)Si(OH), (NH₄O)₂ (C₅H₁₁)Si(OH), (NH₄O)₂(C₈H₁₇)Si(OH), (NaO)₃(CH₃)Si, (NaO)₃(C₂H₅)Si, (NaO)₃(C₅H₁₁)Si, (NaO)₃(C₈H₁₇)Si, (KO)₃(CH₃)Si, (KO)₃(C₂H₅)Si, (KO)₃(C₅H₁₁)Si, (KO)₃(C₈H₁₇)Si, (NH₄O)₃(CH₃)Si, (NH₄O)₃(C₂H₅)Si, NH₄O)₃(C₅H₁₁)Si, (NH₄O)₃(C₈H₁₇)Si, (NaO)(CH₃)₂Si(OH), (NaO)(C₂H₅)₂Si(OH), (KO)(CH₃)₂Si(OH), (KO)(C₂H₅)₂Si(OH), (NaO)₂(CH₃)₂Si, (NaO)₂(C₂H₅)₂Si, (KO)₂(CH₃)₂Si, (KO)₂(C₂H₅)₂Si, Ca²⁺[(O⁻)(CH₃)Si(OH)₂]₂, Ca²⁺[(O⁻)(C₂H₅)Si(OH)₂]₂, Ca²⁺[(O⁻)(C₅H₁₁)Si(OH)₂], Ca²⁺[(O⁻)(C₈H₁₇)Si(OH)₂]₂, Ca²⁺[(O⁻)(CH₃)₂Si(OH)]₂, Ca²⁺[(O⁻)(C₂H₅)₂Si(OH)]₂, Ca²⁺[(O⁻)₂(CH₃)—Si(OH)], Ca²⁺[(O⁻)₂(C₂H₅)Si(OH)], Ca²⁺[(O⁻)₂(C₅H₁₁)Si(OH)], Ca²⁺[(O⁻)₂(C₈H₁₇)Si(OH)], Ca²⁺[(O⁻)₂-(CH₃)₂Si], Ca²⁺[(O⁻)₂(C₂H₅)₂Si] and mixtures thereof.

In a preferred embodiment, the at least one hydrophobizing agent is added to the dispersion I in step (B).

In another preferred embodiment, the at least one magnetic particle has been pre-treated with the at least one hydrophobizing agent before the contacting of dispersion I in step (B).

In a preferred embodiment, the at least one hydrophobizing agent or mixtures thereof may polymerize before or during contacting the magnetic particle.

In another preferred embodiment, the at least one hydrophobizing agent is sodium or potassium dimethylsiliconate.

In another preferred embodiment, the at least one hydrophobized magnetic particle is a magnetite particle that has been treated with a hydrophobizing agent and preferably with the hydrophobizing agent sodium or potassium dimethylsiliconate.

In a preferred embodiment, the at least one hydrophobizing agent is present as a coating on the surface of the magnetic particles in an amount, based on the total weight of the hydrophobized magnetic particle, of from 0.01 to 10 wt. %, preferably from 0.1 to 5 wt. %.

In a preferred embodiment, the at least one magnetic particle is a hydrophobized magnetic particle.

According to the presently claimed invention, the at least one magnetic particle may be predispersed in a dispersion medium. Preferably, the amount of dispersion medium for predispersing the magnetic particles is generally selected so that a slurry or dispersion is obtained which is readily steerable and/or conveyable. In a preferred embodiment, the slurry or dispersion comprises between 10 and 60 wt. % magnetic particles based on the weight of the slurry or dispersion.

According to the presently claimed invention, the dispersion of the magnetic particles can be produced by all methods known to those skilled in the art. In a preferred embodiment, the magnetic particles to be dispersed and the appropriate amount of dispersion medium or mixture of dispersion media are combined in a suitable reactor, and stirred by means of devices known to those skilled in the art. For example, such a device is a mechanical propeller stirrer. The stirring may occur at a temperature of from about 1 to about 80° C. and preferably at ambient temperature.

Step (B) of the process of the invention is preferably carried out at a temperature of from 1 to 80° C., more preferably from 20 to 40° C. and even more preferably at ambient temperature.

The contacting according to step (B) of the process according to the presently claimed invention may be conducted in any apparatus known to the skilled artisan. For example, the dispersion I and the at least one magnetic particle, optionally together with at least one collector and/or the at least one hydrophobizing agent, are combined and mixed in the appropriate amounts in suitable mixing apparatuses that are known to those skilled in the art, such as mills including ball mills.

In a preferred embodiment, the dispersion I in step (B) provides a solid content of from 1 to 60 wt. %, more preferably from 10 to 60 wt. % and even more preferably from 20 to 45 wt. %, based on the whole amount of solids that have to be dispersed.

In another preferred embodiment, the at least one valuable matter containing material and the at least one second material is comminuted, for example by milling as described above, to particles, preferably having a particle size of from 100 nm to 400 μm in or before step (B).

According to the presently claimed invention, the amount of dispersion medium I in step (A) and/or step (B) can generally be selected, so that a dispersion I is obtained which is readily steerable and/or conveyable.

After performing step (B) of the process according to the presently claimed invention, a mixture may be obtained that comprises the further components of the mixture and agglomerates of the at least valuable matter containing material and the at least one magnetic particle, wherein at least one collector and/or hydrophobizing agent is at least partly located between the at least one valuable matter containing material and the at least one magnetic particle.

In a preferred embodiment, the magnetic particle and the at least one valuable matter containing material form an agglomerate in step (B).

In a preferred embodiment, the amount of dispersion medium that needs to be present in step (B) is determined so that a dispersion is introduced into step (C) which has a solid content of from preferably 1 to 80 wt. %, more preferably from 5 to 40 wt. % and even more preferably 10 to 30 wt. % of the dispersion, wherein in each case the solid content is based on the whole amount of solids present in the dispersion.

### Step (C):

Step (C) of the process according to the presently claimed invention comprises the separation of a magnetic fraction I comprising the at least one magnetic particle and the at least one valuable matter containing material agglomerate from the dispersion obtained in step (B) by application of a magnetic field. The magnetic separation may be conducted by any method known to the skilled artisan. In general, methods for separating magnetic parts as a magnetic fraction from a mixture comprising magnetic parts and non-magnetic parts as the remaining non-magnetic fraction are known to the skilled artisan.

In a preferred embodiment, step (C) may be carried out with any magnetic equipment that is suitable to separate magnetic particles from a dispersion, e. g. drum separators, high or low intensity magnetic separators, continuous belt type separators or others.

In another preferred embodiment, step (C) may be carried out by introducing a permanent magnet into the reactor in which the dispersion of step (B) is present. In a preferred embodiment, a dividing wall composed of non-magnetic material, for example the wall of the reactor, may be present between the permanent magnet and the mixture to be treated. In a further preferred embodiment, an electromagnet is used in step (C) which is only magnetic, when an electric current flows. Suitable apparatuses are known to those skilled in the art.

Suitable apparatus and methods of magnetic separation are described in “Magnetic techniques for the treatment of materials”, Jan Svoboda, Kluwer Academic Publishers, 2004.

In a preferred embodiment, the magnetic separation equipment allows washing the magnetic concentrate during separation with a dispersant, preferably water. The washing preferably allows removing inert material from the magnetic concentrate.

In a preferred embodiment, step (C) is conducted continuously or semi-continuously, wherein preferably the dispersion to be treated flows through a separator. Flow velocities of the dispersion to be treated are in general adjusted to obtain an advantageous yield of separated magnetic agglomerates. In a preferred embodiment, flow velocities of the dispersion to be treated are in the range of 10 mm/s to 1000 mm/s.

The pH-value of the dispersion which is treated in step (C) may preferably be in the range from 5 to 13 and more preferably in the range from 7 to 12. In a preferred embodiment, no adjustment of the pH-value of the dispersion obtained in step (B) is necessary.

Step (C) may be carried out at any suitable temperature. In a preferred embodiment, step (C) is carried out at a temperature from 10 to 60° C. and more preferably at ambient temperature.

In a preferred embodiment, step (C) is performed in a continuous or semi-continuous process, wherein the dispersion is preferably mixed by turbulent flow, and is more preferably not additionally stirred.

In a preferred embodiment, the apparatus used for the magnetic separation in (C) is an apparatus as described in WO 2012/104292 A1.

In another preferred embodiment, the apparatus used for the magnetic separation is an apparatus as described in WO 2011/131411 A1, WO 2011/134710 A1, WO 2011/154178 A1, WO 2011/154204 A1, DE 20 2011 104 707 U1, WO 2011/107353 A1, WO 2012/068142 A1, WO 2012/069387 A1, WO 2012/116909 A1, WO 2012/107274 A1, WO 2013/167634 A1 or WO 2014/068142 A1.

In a preferred embodiment, the apparatus comprises at least one loop-like canal through which the dispersion flows.

In a preferred embodiment, the apparatus comprises at least one loop-like canal through which the dispersion flows, and which has at least two inlet and at least two outlets.

In a preferred embodiment, the apparatus for the magnetic separation of the invention is operated in countercurrent.

The magnets can be any magnets known to those skilled in the art, for example permanent magnets, electromagnets and combinations thereof. Permanent magnets are preferred.

In a preferred embodiment, a multiplicity of magnets is arranged around the loop-like canal. In a preferred embodiment, the magnetic constituents present in the dispersion accumulate at least in part, preferably in their entirety, i.e. in a proportion of at least 60 wt. %, more preferably at least 90 wt. %, even more preferably at least 99 wt. %, on the side of the loop-like canal facing the at least one magnet as a result of the magnetic field, wherein the wt. % (% by weight) is based on the total weight of magnetic constituents.

In step (C) the magnetic fraction I comprising the at least one magnetic particle and the at least one valuable matter containing material is preferably separated from the at least one second material.

In a preferred embodiment, the magnetic fraction I, which is obtained after applying a magnetic field and which preferably comprises the at least one magnetic particle and the at least one valuable matter containing material, has a first grade of the at least one valuable matter. A person skilled in the art knows that, in order to determine the grade of the at least one valuable matter containing material, the skilled person needs to isolate the valuable matter containing material, e.g. by separating the at least one valuable matter containing material from the at least one magnetic particle by commonly used methods. The grade may then for example be determined by X-ray fluorescence, fire assay and/or inductively coupled plasma mass-spectroscopy (ICP_MS).

In a preferred embodiment, the magnetic fraction I that is separated in step (C) provides a grade of the at least one valuable matter containing material of 0.000001 to 80 wt. % valuable matter, wherein the weight is based on the valuable matter present in the valuable matter containing material and undesired non-magnetic constituents like the at least one second material, as mentioned above. As used herein, the term grade refers to a valuable matter content present in a valuable matter containing material. A valuable matter containing material present in the magnetic agglomerates with at least one magnetic particle may also have a grade of valuable matter which may be determined after deagglomeration and magnetic separation from the respective magnetic particles. As used herein, the grade is wt. % of a valuable matter of an isolated dry solid. Methods to determine the grade of a valuable matter containing material are commonly known to the skilled person.

In a preferred embodiment, the grade of the at least one valuable matter containing material in magnetic fraction I is more 40 wt. % valuable matter, more preferably more than 45 wt. % valuable matter, even more preferably more than 50 wt. % valuable matter or most preferably more than 55 wt. % valuable matter.

The magnetic fraction I may still comprise significant amounts of undesired compounds. In one embodiment, the magnetic fraction I comprises valuable matter containing material and preferably more than 25 wt. % of at least one second material, more preferably more than 20 wt. %, even more preferably more than 15 wt. % or most preferably more than 10 wt. %.

### Step (D):

Step (D) comprises the dispersing of the magnetic fraction I, which comprises at least one magnetic agglomerate of at least one magnetic particle and at least one valuable matter containing material obtained in step (C), in a dispersion medium II, which contains water and at least one cleavage surfactant, to obtain a dispersion II. To distinguish from optionally present other surfactants, the at least one surfactant that is a mandatory part of the at least one dispersion medium II is defined as cleavage surfactant s.

The magnetic fraction I is dispersed firstly in water and secondly the at least one cleavage surfactant is added, or the magnetic fraction I is dispersed in a mixture of water and the at least one cleavage surfactant. Further, the components in step (D) are agitated to obtain the dispersion II in step (D). Agitation of the obtained dispersion II is then continued to allow for the magnetic particles to be “cleaved”, respectively unloaded, from the at least one valuable matter containing material. Agitation, for example stirring, shaking, pumping or application of ultrasound etc., can be accomplished by any methods and apparatuses known to the skilled artisan, for example using stirring vessels, tanks, stator or tube mixers. The speed of agitation is adjusted in a way that preferably at least no sedimentation occurs. The agitation should be conducted in such a way that at least part of the agglomerates of the valuable matter containing material and the at least one magnetic particle are deagglomerated or destroyed by the agitation and the influence of the at least one cleavage surfactant.

In a preferred embodiment, the added amount of dispersion medium II is an amount to obtain a dispersion II having a solid content of from 0.1 to 50 wt. %, more preferably from 1 to 30 wt. % and even more preferably from 5 to 20 wt. %, in each based on the weight of the whole dispersion II that is obtained. The content of the at least one cleavage surfactant in the dispersion II is preferably in the range from 0.1 to 5 parts by weight based on 100 parts by weight of solids of the magnetic fraction I in the dispersion II, more preferably from 0.2 parts to 4 parts, even more preferably from 0.4 parts to 3 parts, most preferably from 0.6 parts to 2 parts and in particular from 0.8 parts to 1.5 parts. The content of the at least one cleavage surfactant in the dispersion II is preferably in the range from 0.01 parts to 0.5 parts by weight based on 100 parts by weight of the water in the dispersion II, more preferably from 0.02 parts to 0.4 parts, even more preferably from 0.04 parts to 0.3 parts, most preferably from 0.06 parts to 0.2 parts and in particular from 0.08 parts to 0.14 parts. The content of the solids of the magnetic fraction I in the dispersion II is preferably in the range from 1 part to 25 parts by weight based on 100 parts by weight of the water in the dispersion II, more preferably from 2 parts to 20 parts, even more preferably from 2 parts to 14 parts, most preferably from 3 parts to 13 parts, in particular from 4.5 parts to 12 parts and especially from 5 parts to 10 parts. The above contents of the at least one cleavage surfactant refer to the at least one cleavage surfactant and not to any content of any other surfactant, e.g. traces, which are entrapped or remaining in the magnetic fraction I.

In a preferred embodiment, the content of the at least one cleavage surfactant in the dispersion II is in a range from 0.1 to 5 parts by weight based on 100 parts by weight of solids of the magnetic fraction I in the dispersion II.

In a preferred embodiment, the content of the at least one cleavage surfactant in the dispersion II is in a range from 0.01 parts to 0.5 parts by weight based on 100 parts by weight of the water in the dispersion II.

In a preferred embodiment, the content of the solids of the magnetic fraction I in the dispersion II is in a range from 2 parts to 14 parts by weight based on 100 parts by weight of the water in the dispersion II.

In a preferred embodiment, the content of the solids of the magnetic fraction I is in a range from 4.5 parts to 12 parts by weight based on 100 parts by weight of the water in the dispersion II.

Preferably, the at least one cleavage surfactant is a low foaming surfactant in an aqueous environment, e.g. a dispersion or a solution.

In a preferred embodiment, the at least one cleavage surfactant is
(i) at least one alkylethoxylate, which is obtainable by an ethoxylation of R¹—OH with x₁ equivalents of ethylene oxide based on one equivalent R¹—OH, wherein
   R¹ is a branched or linear, unsubstituted C11-C18 alkyl or branched or linear, unsubstituted C11-C18 alkenyl, and
   x₁ is a number larger than or equal to 4.0 and smaller than or equal to 6.5.

In another preferred embodiment, the at least one cleavage surfactant is
(ii) at least one alkylalkoxyethoxylate, which is obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, wherein
   R² is a branched or linear, unsubstituted C12-C18 alkyl or a branched or linear, unsubstituted C12-C18 alkenyl,
   x₂ is a number larger than or equal to 4.0 and smaller than or equal to 14.0, and
   y₂ is a number larger than or equal to 1.7 and smaller than or equal to 8.0.

In the following, the prefix n-indicates a linear aliphatic residue with no aliphatic substituents at the sole carbon atom chain in the molecule. The prefix iso-indicates a branched aliphatic residue with one or more aliphatic substituents at the carbon atom chain in the molecule, which carbon atom chain attaches to the OH-group and if this condition is fulfilled, possesses the most carbon atom as a chain. The sole OH-group in R¹—OH or R²—OH can be attached at a primary carbon atom and thus R¹—OH or R²—OH is a primary alcohol. The sole OH-group in R¹—OH or R²—OH can attach at a secondary carbon atom and thus R¹—OH or R²—OH is a secondary alcohol. In case of a branched aliphatic residue, the sole OH-group in R¹—OH or R²—OH can be attached at a tertiary carbon atom and thus R¹—OH or R²—OH is a tertiary alcohol.

Preferably, R¹—OH and R²—OH are primary alcohols or secondary alcohols. Very preferably, R¹—OH and R²—OH are primary alcohols, in case R¹ and R² are branched, and R¹—OH and R²—OH are primary alcohols or secondary alcohols, in case R¹ and R² are linear. Most preferably, R¹ and R² are primary alcohols.

Branched or linear, unsubstituted C11-C18 alkyl is for example n-undecyl or iso-undecyl, in particular 2-methyl-dec-1-yl; n-dodecyl or iso-dodecyl, in particular 2-methyl-undec-1-yl, 9-methyl undec-1-yl, 4,8-dimethyl-dec-1-yl, 2,6,8-trimethyl-non-1-yl, 2-ethyl-dec-1-yl, 2-ethyl-3-methyl-non-1-yl, 2,4-diethyl-oct-1-yl, 2-butyl-oct-1-yl; n-tridecyl or iso-tridecyl, in particular 2-methyl-do-dec-1-yl, 11-methyl-dodec-1-yl, 2,4,8-trimethyl-dec-1-yl, 2,4,6,8-tetramethyl-non-1-yl, 2-ethyl-un-dec-1-yl, 2,2-diethyl-non-1-yl, 2-propyl-dec-1-yl; n-tetradecyl or iso-tetradecyl, in particular 2-me-thyl-tridec-1-yl, 2,6,10-trimethyl-undec-1-yl, 2,4,6,8-tetramethyl-dec-1-yl, 2-ethyl-dodec-1-yl, 7-ethyl-2-methyl-undec-1-yl, 2-(2-methylpropyl)-dec-1-yl, 2-butyl-2-ethyl-6-methyl-hept-1-yl, 2-pen-tyl-non-1-yl, 2-hexyl-oct-1-yl; n-pentadecyl or iso-pentadecyl, in particular 2-methyl-tetradec-1-yl, 13-methyl-tetradec-1-yl, 3,7,11-trimethyl-dodec-1-yl, 2-propyl-dodec-1-yl, 3-hexyl-non-1-yl; n-hexadecyl or iso-hexadecyl, in particular 2-methyl-pentadec-1-yl, 14-methyl-pentadec-1-yl, 2,4,8-trimethyl-tridec-1-yl, 4,8,12-trimethyl-tridec-1-yl, 2-ethyl-tetradec-1-yl, 2-butyl-dodec-1-yl, 2-hexyl-decan-1-yl; n-heptadecyl or iso-heptadecyl, in particular 2-methyl-hexadec-1-yl; n-octadecyl or iso-octadecyl, in particular 2-methyl-heptadec-1-yl, or a mixture thereof.

Branched or linear, unsubstituted C11-C18 alkenyl is for example undec-10-en-1-yl; n-octadecenyl, in particular (E)-octadec-9-en-1yl, (Z)-octadec-9-en-1yl, (9Z,12E)-octadeca-9,12-dien-1yl, (Z,Z,Z)-octadeca-9,12,15-trien-1-yl, or iso-octadecenyl, or a mixture thereof.

Branched or linear, unsubstituted C12-C18 alkyl is for example n-dodecyl or iso-dodecyl, in particular 2-methyl-undec-1-yl, 9-methyl-undec-1-yl, 4,8-dimethyl-dec-1-yl, 2,6,8-trimethyl-non-1-yl, 2-ethyl-dec-1-yl, 2-ethyl-3-methyl-non-1-yl, 2,4-diethyl-oct-1-yl, 2-butyl-oct-1-yl; n-tridecyl or iso-tridecyl, in particular 2-methyl-dodec-1-yl, 11-methyl-dodec-1-yl, 2,4,8-trimethyl-dec-1-yl, 2,4,6,8-tetramethyl-non-1-yl, 2-ethyl-undec-1-yl, 2,2-diethyl-non-1-yl, 2-propyl-dec-1-yl; n-tetradecyl or iso-tetradecyl, in particular 2-methyl-tridec-1-yl, 2,6,10-trimethyl-undec-1-yl, 2,4,6,8-tetramethyl-dec-1-yl, 2-ethyl-dodec-1-yl, 7-ethyl-2-methyl-undec-1-yl, 2-(2-methylpropyl)-dec-1-yl, 2-butyl-2-ethyl-6-methyl-hept-1-yl, 2-pentyl-non-1-yl, 2-hexyl-oct-1-yl; n-pentadecyl or iso-pentadecyl, in particular 2-methyl-tetradec-1-yl, 13-methyl-tetradec-1-yl, 3,7,11-trimethyl-dodec-1-yl, 2-propyl-dodec-1-yl, 3-hexyl-non-1-yl; n-hexadecyl or iso-hexadecyl, in particular 2-methyl-pentadec-1-yl, 14-methyl-pentadec-1-yl, 2,4,8-trimethyl-tridec-1-yl, 4,8,12-trimethyl-tridec-1-yl, 2-ethyl-tetradec-1-yl, 2-butyl-dodec-1-yl, 2-hexyl-decan-1-yl; n-heptadecyl or iso-heptadecyl, in particular 2-me-thyl-hexadec-1-yl; n-octadecyl or iso-octadecyl, in particular 2-methyl-hepta-dec-1-yl, or a mixture thereof.

Branched or linear, unsubstituted C12-C18 alkenyl is for example n-octadecenyl, in particular (E)-octadec-9-en-1yl, (Z)-octadec-9-en-1yl, (9Z,12E)-octadeca-9,12-dien-1yl, (Z,Z,Z)-octadeca-9,12,15-trien-1-yl, or iso-octadecenyl, or a mixture thereof.

The alkoxylation of the alcohols R¹—OH or R²—OH can be conducted by well-known procedures. The respective alcohol is reacted with ethylene oxide, in case of R¹—OH, and with ethylene oxide and propylene oxide, ethylene oxide and butylene oxide or ethylene oxide, propylene oxide and butylene oxide, in case of R²—OH, in the presence of a suitable catalyst, for example a conventional basic catalyst such as potassium hydroxide. In case ethylene oxide and propylene oxide and/or butylene oxide are used, the alkoxides may be added as blocks in either order or may be added randomly, i.e. a mixture of alkylene oxides is added. Preferably, ethylene oxide is reacted first with R²—OH and is followed by propylene oxide and/or butylene oxide or the ethylene oxide and the propylene oxide and/or butylene oxide are reacted randomly with R²—OH. Very preferably, ethylene oxide is reacted first with R²—OH and is followed by propylene oxide and/or butylene oxide. Preferably, the alkoxylation is conducted with a basic catalyst, more preferably with an alkali hydroxide, very preferably with potassium hydroxide or sodium hydroxide, particularly with potassium hydroxide.

In a preferred embodiment, the at least one cleavage surfactant, i.e. (i) the at least one alkylethoxylate and (ii) the at least one alkylalkoxyethoxylate, is not end-capped. End-capping means that the reaction product obtained from the alkoxylation reaction or alkoxylation reactions is not further reacted with the target to convert the OH-groups of the reaction products, for example into an ether by an alkylation or an ester by an esterification.

In a preferred embodiment, x₁ is a number larger than or equal to 4.0 and smaller than or equal to 6.5. More preferably, x₁ is a number larger than or equal to 4.3 and smaller than or equal to 6.5. Very preferably, x₁ is a number larger than or equal to 4.5 and smaller than or equal to 6.5. Particularly, x₁ is a number larger than or equal to 4.7 and smaller than or equal to 6.5. Very particularly, x₁ is a number larger than or equal to 4.8 and smaller than or equal to 6.5. Especially, x₁ is a number equal to or larger than or equal to 5.0 and smaller than or equal to or equal to 6.5.

In a more preferred embodiment, the process for the separation of at least one valuable matter containing material from a dispersion I comprising said at least one valuable matter containing material and at least one second material, wherein the process comprises the steps of:
(A) providing a dispersion I comprising the at least one valuable matter containing material and the at least one second material;
(B) contacting the dispersion I of step (A) with at least one magnetic particle to obtain a contacted dispersion I;
(C) separating a magnetic fraction I from the contacted dispersion I by applying a magnetic field, wherein the magnetic fraction I comprises the at least one magnetic particle and the at least one valuable matter containing material;
(D) dispersing the magnetic fraction I in at least one dispersion medium II, which contains water and at least one cleavage surfactant, to obtain a dispersion II; and
(E) separating a non-magnetic fraction II from the dispersion II, wherein the non-magnetic fraction II comprises at least one valuable matter containing material;
wherein the at least one cleavage surfactant is selected from the group consisting of
   i. alkylethoxylates, which are obtainable by an ethoxylation of R¹—OH with x₁ equivalents of ethylene oxide based on one equivalent R¹—OH, wherein
      R¹ is a branched or linear, unsubstituted C11-C18 alkyl or branched or linear, unsubstituted C11-C18 alkenyl, and
      x₁ is a number larger than or equal to 4.0 and smaller than or equal to 6.5, preferably, x₁ is a number larger than or equal to 4.3 and smaller than or equal to 6.5, more preferably, x₁ is a number larger than or equal to 4.5 and smaller than or equal to 6.5, particularly, x₁ is a number larger than or equal to 4.7 and smaller than or equal to 6.5, very particularly, x₁ is a number larger than or equal to 4.8 and smaller than or equal to 6.5. especially, x₁ is a number equal to or larger than or equal to 5.0 and smaller than or equal to or equal to 6.5;
      and
   ii. alkylalkoxyethoxylates, which are obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, wherein
      R² is a branched or linear, unsubstituted C12-C18 alkyl or branched or linear, unsubstituted C12-C18 alkenyl,
      x₂ is a number larger than or equal to 4.0 and smaller than or equal to 14.0, and
      y₂ is a number larger than or equal to 1.7 and smaller than or equal to 8.0.

In another more preferred embodiment, use of at least one cleavage surfactant for cleaving agglomerates comprising magnetic particles and at least one valuable matter containing material to obtain magnetic particles and at least one valuable matter containing material separately, wherein the at least one cleavage surfactant is selected from the group consisting of
iii. alkylethoxylates, which are obtainable by an ethoxylation of R¹—OH with x₁ equivalents of ethylene oxide based on one equivalent R¹—OH, wherein
   R¹ is a branched or linear, unsubstituted C11-C18 alkyl or branched or linear, unsubstituted C11-C18 alkenyl, and
   x₁ is a number larger than or equal to 4.0 and smaller than or equal to 6.5, preferably, x₁ is a number larger than or equal to 4.3 and smaller than or equal to 6.5, more preferably, x₁ is a number larger than or equal to 4.5 and smaller than or equal to 6.5, particularly, x₁ is a number larger than or equal to 4.7 and smaller than or equal to 6.5, very particularly, x₁ is a number larger than or equal to 4.8 and smaller than or equal to 6.5. especially, x₁ is a number equal to or larger than or equal to 5.0 and smaller than or equal to or equal to 6.5;
   and
iv. alkylalkoxyethoxylates, which are obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, wherein
   R² is a branched or linear, unsubstituted C12-C18 alkyl or branched or linear, unsubstituted C12-C18 alkenyl,
   x₂ is a number larger than or equal to 4.0 and smaller than or equal to 14.0, and
   y₂ is a number larger than or equal to 1.7 and smaller than or equal to 8.0.

In a preferred embodiment, R¹ is a branched or linear, unsubstituted C12-C18 alkyl or a branched or linear, unsubstituted C12-C18 alkenyl. Most preferably, R¹ is a linear, unsubstituted C12-C18 alkyl or a branched, unsubstituted C13 alkyl.

In a preferred embodiment, x₂ is a number larger than or equal to 4.4 and smaller than or equal to 13.0 and y₂ is a number larger than or equal to 1.8 and smaller than or equal to 7.0. Very preferably, x₂ is a number larger than or equal to 4.7 and smaller than or equal to 12.5 and y₂ is a number larger than or equal to 1.9 and smaller than or equal to 6.6.

In a preferred embodiment, x₂ is larger than or equal to y₂. More preferably, the ratio of x₂ to y₂ is larger than or equal to 1.2 and smaller than or equal to 4, most preferably the ratio of x₂ to y₂ is larger than or equal to 1.4 and smaller than or equal to 3.5, particularly the ratio of x₂ to y₂ is larger than or equal to 1.6 and smaller than or equal to 3.0, very particularly the ratio of x₂ to y₂ is larger than or equal to 1.8 and smaller than or equal to 2.4.

In a preferred embodiment, x₂ is a number larger than or equal to 4.0 and smaller than or equal to 14.0, y₂ is a number larger than or equal to 1.7 and smaller than or equal to 8.0 and x₂ is larger than or equal to y₂.

In a preferred embodiment, R² is a branched or linear, unsubstituted C12-C16 alkyl. More preferably, R² is a branched or linear, unsubstituted C12-C15 alkyl. Even more preferably, R² is a branched or linear, unsubstituted C13-C15 alkyl. In particular, R² is a branched, unsubstituted C13 alkyl.

In a more preferred embodiment, the process for the separation of at least one valuable matter containing material from a dispersion I comprising said at least one valuable matter containing material and at least one second material, wherein the process comprises the steps of:
(A) providing a dispersion I comprising the at least one valuable matter containing material and the at least one second material;
(B) contacting the dispersion I of step (A) with at least one magnetic particle to obtain a contacted dispersion I;
(C) separating a magnetic fraction I from the contacted dispersion I by applying a magnetic field, wherein the magnetic fraction I comprises the at least one magnetic particle and the at least one valuable matter containing material;
(D) dispersing the magnetic fraction I in at least one dispersion medium II, which contains water and at least one cleavage surfactant, to obtain a dispersion II; and
(E) separating a non-magnetic fraction II from the dispersion II, wherein the non-magnetic fraction II comprises at least one valuable matter containing material;
wherein the at least one cleavage surfactant is selected from the group consisting of
   i. alkylethoxylates, which are obtainable by an ethoxylation of R¹—OH with x₁ equivalents of ethylene oxide based on one equivalent R¹—OH, wherein
      R¹ is a branched or linear, unsubstituted C11-C18 alkyl or branched or linear, unsubstituted C11-C18 alkenyl, and
      x₁ is a number larger than or equal to 4.0 and smaller than or equal to 6.5, preferably, x₁ is a number larger than or equal to 4.3 and smaller than or equal to 6.5. more preferably, x₁ is a number larger than or equal to 4.5 and smaller than or equal to 6.5, particularly, x₁ is a number larger than or equal to 4.7 and smaller than or equal to 6.5, very particularly, x₁ is a number larger than or equal to 4.8 and smaller than or equal to 6.5, especially, x₁ is a number equal to or larger than or equal to 5.0 and smaller than or equal to or equal to 6.5;
      and
   ii. alkylalkoxyethoxylates, which are obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, wherein
      R² is a branched or linear, unsubstituted C12-C18 alkyl or branched or linear, unsubstituted C12-C18 alkenyl,
      x₂ is a number larger than or equal to 4.0 and smaller than or equal to 14.0, preferably x₂ is a number larger than or equal to 4.4 and smaller than or equal to 13.0, more preferably x₂ is a number larger than or equal to 4.7 and smaller than or equal to 12.5, and
      y₂ is a number larger than or equal to 1.7 and smaller than or equal to 8.0, preferably is a number larger than or equal to 1.8 and smaller than or equal to 7.0, more preferably a number larger than or equal to 1.9 and smaller than or equal to 6.6.

In another more preferred embodiment, use of at least one cleavage surfactant for cleaving agglomerates comprising magnetic particles and at least one valuable matter containing material to obtain magnetic particles and at least one valuable matter containing material separately, wherein the at least one cleavage surfactant is selected from the group consisting of
i. alkylethoxylates, which are obtainable by an ethoxylation of R¹—OH with x₁ equivalents of ethylene oxide based on one equivalent R¹—OH, wherein
   R¹ is a branched or linear, unsubstituted C11-C18 alkyl or branched or linear, unsubstituted C11-C18 alkenyl, and
   x₁ is a number larger than or equal to 4.0 and smaller than or equal to 6.5, preferably, x₁ is a number larger than or equal to 4.3 and smaller than or equal to 6.5. more preferably, x₁ is a number larger than or equal to 4.5 and smaller than or equal to 6.5, particularly, x₁ is a number larger than or equal to 4.7 and smaller than or equal to 6.5, very particularly, x₁ is a number larger than or equal to 4.8 and smaller than or equal to 6.5, especially, x₁ is a number equal to or larger than or equal to 5.0 and smaller than or equal to or equal to 6.5;
   and
ii. alkylalkoxyethoxylates, which are obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, wherein
   R² is a branched or linear, unsubstituted C12-C18 alkyl or branched or linear, unsubstituted C12-C18 alkenyl,
   x₂ is a number larger than or equal to 4.0 and smaller than or equal to 14.0, preferably x₂ is a number larger than or equal to 4.4 and smaller than or equal to 13.0, more preferably x₂ is a number larger than or equal to 4.7 and smaller than or equal to 12.5, and
   y₂ is a number larger than or equal to 1.7 and smaller than or equal to 8.0, preferably is a number larger than or equal to 1.8 and smaller than or equal to 7.0, more preferably a number larger than or equal to 1.9 and smaller than or equal to 6.6.

In a more preferred embodiment, the process for the separation of at least one valuable matter containing material from a dispersion I comprising said at least one valuable matter containing material and at least one second material, wherein the process comprises the steps of:
(A) providing a dispersion I comprising the at least one valuable matter containing material and the at least one second material;
(B) contacting the dispersion I of step (A) with at least one magnetic particle to obtain a contacted dispersion I;
(C) separating a magnetic fraction I from the contacted dispersion I by applying a magnetic field, wherein the magnetic fraction I comprises the at least one magnetic particle and the at least one valuable matter containing material;
(D) dispersing the magnetic fraction I in at least one dispersion medium II, which contains water and at least one cleavage surfactant, to obtain a dispersion II; and
(E) separating a non-magnetic fraction II from the dispersion II, wherein the non-magnetic fraction II comprises at least one valuable matter containing material;
wherein the at least one cleavage surfactant is selected from the group consisting of
   i. alkylethoxylates, which are obtainable by an ethoxylation of R¹—OH with x₁ equivalents of ethylene oxide based on one equivalent R¹—OH, wherein
      R¹ is a branched or linear, unsubstituted C11-C18 alkyl or branched or linear, unsubstituted C11-C18 alkenyl, and
      x₁ is a number larger than or equal to 4.0 and smaller than or equal to 6.5, preferably, x₁ is a number larger than or equal to 4.3 and smaller than or equal to 6.5. more preferably, x₁ is a number larger than or equal to 4.5 and smaller than or equal to 6.5, particularly, x₁ is a number larger than or equal to 4.7 and smaller than or equal to 6.5, very particularly, x₁ is a number larger than or equal to 4.8 and smaller than or equal to 6.5, especially, x₁ is a number equal to or larger than or equal to 5.0 and smaller than or equal to or equal to 6.5;
      and
   ii. alkylalkoxyethoxylates, which are obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, more preferably the alkoxylation of R²—OH is first conducted with x₂ equivalents of ethylene oxide to obtain an ethoxylated intermediate and the ethoxylated intermediate is alkoxylated with y₂ equivalents of an alkylene oxide different from ethylene oxide, which is propylene oxide, butylene oxide or a mixture thereof, wherein
      R² is a branched or linear, unsubstituted C12-C18 alkyl or branched or linear, unsubstituted C12-C18 alkenyl,
      x₂ is a number larger than or equal to 4.0 and smaller than or equal to 14.0, preferably x₂ is a number larger than or equal to 4.4 and smaller than or equal to 13.0, more preferably x₂ is a number larger than or equal to 4.7 and smaller than or equal to 12.5, and
      y₂ is a number larger than or equal to 1.7 and smaller than or equal to 8.0, preferably is a number larger than or equal to 1.8 and smaller than or equal to 7.0, more preferably a number larger than or equal to 1.9 and smaller than or equal to 6.6.

In another more preferred embodiment, use of at least one cleavage surfactant for cleaving agglomerates comprising magnetic particles and at least one valuable matter containing material to obtain magnetic particles and at least one valuable matter containing material separately, wherein the at least one cleavage surfactant is selected from the group consisting of
i. alkylethoxylates, which are obtainable by an ethoxylation of R¹—OH with x₁ equivalents of ethylene oxide based on one equivalent R¹—OH, wherein
   R¹ is a branched or linear, unsubstituted C11-C18 alkyl or branched or linear, unsubstituted C11-C18 alkenyl, and
   x₁ is a number larger than or equal to 4.0 and smaller than or equal to 6.5, preferably, x₁ is a number larger than or equal to 4.3 and smaller than or equal to 6.5. more preferably, x₁ is a number larger than or equal to 4.5 and smaller than or equal to 6.5, particularly, x₁ is a number larger than or equal to 4.7 and smaller than or equal to 6.5, very particularly, x₁ is a number larger than or equal to 4.8 and smaller than or equal to 6.5, especially, x₁ is a number equal to or larger than or equal to 5.0 and smaller than or equal to or equal to 6.5;
   and
ii. alkylalkoxyethoxylates, which are obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, more preferably the alkoxylation of R²—OH is first conducted with x₂ equivalents of ethylene oxide to obtain an ethoxylated intermediate and the ethoxylated intermediate is alkoxylated with y₂ equivalents of an alkylene oxide different from ethylene oxide, which is propylene oxide, butylene oxide or a mixture thereof, wherein
   R² is a branched or linear, unsubstituted C12-C18 alkyl or branched or linear, unsubstituted C12-C18 alkenyl,
   x₂ is a number larger than or equal to 4.0 and smaller than or equal to 14.0, preferably x₂ is a number larger than or equal to 4.4 and smaller than or equal to 13.0, more preferably x₂ is a number larger than or equal to 4.7 and smaller than or equal to 12.5, and
   y₂ is a number larger than or equal to 1.7 and smaller than or equal to 8.0, preferably is a number larger than or equal to 1.8 and smaller than or equal to 7.0, more preferably a number larger than or equal to 1.9 and smaller than or equal to 6.6.

In a more preferred embodiment, the process for the separation of at least one valuable matter containing material from a dispersion I comprising said at least one valuable matter containing material and at least one second material, wherein the process comprises the steps of:
(A) providing a dispersion I comprising the at least one valuable matter containing material and the at least one second material;
(B) contacting the dispersion I of step (A) with at least one magnetic particle to obtain a contacted dispersion I;
(C) separating a magnetic fraction I from the contacted dispersion I by applying a magnetic field, wherein the magnetic fraction I comprises the at least one magnetic particle and the at least one valuable matter containing material;
(D) dispersing the magnetic fraction I in at least one dispersion medium II, which contains water and at least one cleavage surfactant, to obtain a dispersion II, preferably the content of the at least one cleavage surfactant in the dispersion II is in a range from 0.1 to 5 parts by weight based on 100 parts by weight of solids of the magnetic fraction I in the dispersion II; and
(E) separating a non-magnetic fraction II from the dispersion II, wherein the non-magnetic fraction II comprises at least one valuable matter containing material;
wherein the at least one cleavage surfactant is selected from the group consisting of
   i. alkylethoxylates, which are obtainable by an ethoxylation of R¹—OH with x₁ equivalents of ethylene oxide based on one equivalent R¹—OH, wherein
      R¹ is a branched or linear, unsubstituted C11-C18 alkyl or branched or linear, unsubstituted C11-C18 alkenyl, and
      x₁ is a number larger than or equal to 4.0 and smaller than or equal to 6.5, preferably, x₁ is a number larger than or equal to 4.3 and smaller than or equal to 6.5. more preferably, x₁ is a number larger than or equal to 4.5 and smaller than or equal to 6.5, particularly, x₁ is a number larger than or equal to 4.7 and smaller than or equal to 6.5, very particularly, x₁ is a number larger than or equal to 4.8 and smaller than or equal to 6.5, especially, x₁ is a number equal to or larger than or equal to 5.0 and smaller than or equal to or equal to 6.5;
      and
   ii. alkylalkoxyethoxylates, which are obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, more preferably the alkoxylation of R²—OH is first conducted with x₂ equivalents of ethylene oxide to obtain an ethoxylated intermediate and the ethoxylated intermediate is alkoxylated with y₂ equivalents of an alkylene oxide different from ethylene oxide, which is propylene oxide, butylene oxide or a mixture thereof, wherein
      R² is a branched or linear, unsubstituted C12-C18 alkyl or branched or linear, unsubstituted C12-C18 alkenyl,
      x₂ is a number larger than or equal to 4.0 and smaller than or equal to 14.0, preferably x₂ is a number larger than or equal to 4.4 and smaller than or equal to 13.0, more preferably x₂ is a number larger than or equal to 4.7 and smaller than or equal to 12.5, and
      y₂ is a number larger than or equal to 1.7 and smaller than or equal to 8.0, preferably is a number larger than or equal to 1.8 and smaller than or equal to 7.0, more preferably a number larger than or equal to 1.9 and smaller than or equal to 6.6.

In another more preferred embodiment, use of at least one cleavage surfactant for cleaving agglomerates comprising magnetic particles and at least one valuable matter containing material to obtain magnetic particles and at least one valuable matter containing material separately, wherein the at least one cleavage surfactant is selected from the group consisting of
i. alkylethoxylates, which are obtainable by an ethoxylation of R¹—OH with x₁ equivalents of ethylene oxide based on one equivalent R¹—OH, wherein
   R¹ is a branched or linear, unsubstituted C11-C18 alkyl or branched or linear, unsubstituted C11-C18 alkenyl, and
   x₁ is a number larger than or equal to 4.0 and smaller than or equal to 6.5, preferably, x₁ is a number larger than or equal to 4.3 and smaller than or equal to 6.5. more preferably, x₁ is a number larger than or equal to 4.5 and smaller than or equal to 6.5, particularly, x₁ is a number larger than or equal to 4.7 and smaller than or equal to 6.5, very particularly, x₁ is a number larger than or equal to 4.8 and smaller than or equal to 6.5, especially, x₁ is a number equal to or larger than or equal to 5.0 and smaller than or equal to or equal to 6.5;
   and
ii. alkylalkoxyethoxylates, which are obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, more preferably the alkoxylation of R²—OH is first conducted with x₂ equivalents of ethylene oxide to obtain an ethoxylated intermediate and the ethoxylated intermediate is alkoxylated with y₂ equivalents of an alkylene oxide different from ethylene oxide, which is propylene oxide, butylene oxide or a mixture thereof, wherein
   R² is a branched or linear, unsubstituted C12-C18 alkyl or branched or linear, unsubstituted C12-C18 alkenyl,
   x₂ is a number larger than or equal to 4.0 and smaller than or equal to 14.0, preferably x₂ is a number larger than or equal to 4.4 and smaller than or equal to 13.0, more preferably x₂ is a number larger than or equal to 4.7 and smaller than or equal to 12.5, and
   y₂ is a number larger than or equal to 1.7 and smaller than or equal to 8.0, preferably is a number larger than or equal to 1.8 and smaller than or equal to 7.0, more preferably a number larger than or equal to 1.9 and smaller than or equal to 6.6.

Oxo-alcohols are prepared by a hydroformylation reaction via adding carbon monoxide and hydrogen to an olefin to obtain an aldehyde. This is followed by hydrogenation of the aldehyde to obtain the oxo-alcohol. Guerbet alcohols are prepared by a converting a primary starting alcohol into its beta-alkylated dimer alcohol with loss of one equivalent of water.

The “cleavage” or “unloading” in step (D) can additionally be supported by adding in step (D) organic solvents, basic compounds, acidic compounds, oxidants, reducing agents, a second surfactant that is different from the at least one cleavage surfactant or mixtures thereof. The second surfactant that is different from the at least one cleavage surfactant is not a surfactant as defined under (i) as at least one alkylethoxylate or (ii) as at least one alkylalkoxyethoxylate. In case a second surfactant that is different from the at least one cleavage surfactant is added, its amount is preferably below 30 parts by weight of the second surfactant that is different from the at least one cleavage surfactant based on 100 parts by weight of the at least one cleavage surfactant, more preferably below 20 parts by weight, very preferably above 0.1 parts by weight and below 10 parts by weight and particularly above 0.5 parts by weight and below 5 parts by weight. Very particularly, the at least one cleavage surfactant is the sole surfactant added in step (D), especially the sole surfactant added in step (D) and step (E), very especially the sole surfactant added after step (C) of the process, and most especially the sole surfactant added after step (B) of the process.

Examples of basic compounds are aqueous solutions of basic compounds, for example aqueous solutions of alkali metal and/or alkaline earth metal hydroxides, such as KOH or NaOH; lime water, aqueous ammonia solutions, aqueous solutions of organic amines of the general formula (R⁷)₄N⁺, where each R⁷ is selected independently from linear of branched C1-C8 alkyl.

After step (D) the obtained dispersion II comprises magnetic particles, at least one valuable matter containing material and undesired constituents, such as the at least one second material, that have not been removed in step (C).

### Step (E):

Step (E) of the process according to the presently claimed invention comprises the separation of a non-magnetic fraction II from the dispersion II, wherein the non-magnetic fraction II comprises at least one valuable matter containing material. The separation results in a non-magnetic fraction II and a magnetic fraction II. The magnetic fraction II obtained in step (E) comprises the magnetic particles and ideally very few to none of the at least one valuable matter containing material.

In a preferred embodiment, the separation in step (E) of the process according to the present invention is conducted by the application of a magnetic field, flotation, dense media separation, gravity separation, spiral concentrator or combinations thereof, more preferably by the application of a magnetic field.

As already outlined in respect of step (C), in general, any method known to the skilled artisan for the separation using a magnetic field can be used. Most preferably, step (E) is be conducted using the method and the apparatus as mentioned in respect of step (C), particularly a method and an apparatus as disclosed in WO 2014/068142 A1.

In a preferred embodiment, in step (E) the separation of the non-magnetic fraction II from the dispersion II comprises the separation of a magnetic fraction II from the dispersion II by applying a magnetic field, a flotation, a dense media separation, a gravity separation, a concentration with a spiral concentrator and combinations thereof.

In a preferred embodiment, in step (E) the separation of the magnetic fraction II from the dispersion II comprises applying a magnetic field.

### Optional Step (F):

The non-magnetic fraction II, which contains the at least one valuable matter containing material is optionally further processed to obtain the at least one valuable matter. This processing is for example a smelting, an extracting and/or a wet chemical refining.

Smelting is a process to convert an ore, scrap or a material mixture containing different metals into a form from which the desired metals can be skimmed as a metal layer and the undesired metal oxides, e.g. silicates, alumina, etc., remain as the slag. During smelting, a silicate-rich liquid phase may separate from the heavier metal melt. The latter is flowing through dedicated openings in the melting vessel and is further processed. The phase separation is however sometimes not complete, but a fraction of the desired metal becomes trapped in the liquid slag phase and remains dispersed there after solidification resulting in a so-called mixing layer. In general, oxidative and reductive smelting conditions are distinguished. The slag material of the so-called mixing layer can be separated according to the presently claimed invention and can either be obtained under reductive conditions or under oxidative conditions. For example, slag produced in Platinum Group Metals recovery operations, for example in Pt mines or old catalyst reprocessing etc., is usually formed under reductive conditions, which are exemplarily explained in the following. The energy needed to heat the mass to beyond the melting point is in general provided by an external heating, e.g. gas burners, or an electric arc. Often, carbon or other reducing materials are added. The goal is to reduce noble metal compounds to metal state. Reduced metals and the oxidic phase are immiscible and demix. Slags produced under reductive conditions often contain residual Platinum Group Metals as free metals or alloys with other transition metals, particularly iron. These alloys are often ferromagnetic and can be separated from the slag matrix by a magnetic field after liberation. The losses of Platinum Group Metals into slag are almost exclusively due to incomplete demixing of the liquid metal and liquid slag phases-no significant formation of Platinum Group Metals solid solution in the slag occurs.

In a smelter that is operated under reductive conditions, most of the base metal sulfides remain as sulfides. Some metal species, e.g. Platinum Group Metals, may also remain as the native metal or tend to migrate into the magnetic fraction. Magnetite is often fed into the smelter to support the formation of the slag. Platinum and also rhodium preferably feature this behavior to migrate to the magnetic fraction thus after the smelting process these precious group metals are hidden in the magnetic fraction, which is preferably in the slag, as dopants.

Is a smelter operated under oxidative conditions, the base metals sulfides and also some native metals compounds are oxidized. In this case, the magnetic separation process according to the presently claimed invention is rarely be used without pre-treatment. However, if a surface treatment, for example a selective sulfidization of the desired metal of value, is preferably executed, the magnetic separation process according to the presently claimed invention can be employed as described herein. Besides the preferred sulfidization, also other surface treatments can be used to convert the desired metal species into a sulfidic, native or magnetic form. These treatments are known to the skilled artisan.

The process according to the presently claimed invention allows for optional step (F) to be conducted more efficiently, for example with lower energy costs in step (F), because the grade of the at least one valuable matter containing material of non-magnetic fraction II in step (E) is increased and thus, the amount of material to be treated in the subsequent steps of the valuable recovery process is decreased. In addition, the capacity of the optional step (F) may be increased at a fixed apparatus size employed at the optional step (F).

In a preferred embodiment, the process of the presently claimed invention further comprises step (F) that is conducted after step (E):
(F) processing of the non-magnetic fraction II obtained in step (E) by smelting, extracting and/or wet chemical refining.

The presently claimed invention is illustrated in more detail by the following embodiments and combinations of embodiments which results from the corresponding dependency references and links:

### Embodiments

I. A process for the separation of at least one valuable matter containing material from a dispersion I comprising said at least one valuable matter containing material and at least one second material, wherein the process comprises the steps of:
   (A) providing a dispersion I comprising the at least one valuable matter containing material and the at least one second material;
   (B) contacting the dispersion I of step (A) with at least one magnetic particle to obtain a contacted dispersion I;
   (C) separating a magnetic fraction I from the contacted dispersion I by applying a magnetic field, wherein the magnetic fraction I comprises the at least one magnetic particle and the at least one valuable matter containing material;
   (D) dispersing the magnetic fraction I in at least one dispersion medium II, which contains water and at least one cleavage surfactant, to obtain a dispersion II; and
   (E) separating a non-magnetic fraction II from the dispersion II, wherein the non-magnetic fraction II comprises at least one valuable matter containing material;
   wherein the at least one cleavage surfactant is selected from the group consisting of
      i. alkylethoxylates, which are obtainable by an ethoxylation of R¹—OH with x₁ equivalents of ethylene oxide based on one equivalent R¹—OH, wherein
         R¹ is a branched or linear, unsubstituted C11-C18 alkyl or branched or linear, unsubstituted C11-C18 alkenyl, and
         x₁ is a number larger than or equal to 4.0 and smaller than or equal to 6.5; and
      ii. alkylalkoxyethoxylates, which are obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, wherein
         R² is a branched or linear, unsubstituted C12-C18 alkyl or branched or linear, unsubstituted C12-C18 alkenyl,
         x₂ is a number larger than or equal to 4.0 and smaller than or equal to 14.0, and
         y₂ is a number larger than or equal to 1.7 and smaller than or equal to 8.0.
II. Use of at least one cleavage surfactant for cleaving agglomerates comprising magnetic particles and at least one valuable matter containing material to obtain magnetic particles and at least one valuable matter containing material separately, wherein the at least one cleavage surfactant is selected from the group consisting of
   (i) alkylethoxylates, which are obtainable by an ethoxylation of R¹—OH with x₁ equivalents of ethylene oxide based on one equivalent R¹—OH, wherein
      R¹ is a branched or linear, unsubstituted C11-C18 alkyl or branched or linear, unsubstituted C11-C18 alkenyl, and
      x₁ is a number larger than or equal to 4.0 and smaller than or equal to 6.5; and
   (ii) alkylalkoxyethoxylates, which are obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, wherein
      R² is a branched or linear, unsubstituted C12-C18 alkyl or branched or linear, unsubstituted C12-C18 alkenyl,
      x₂ is a number larger than or equal to 4.0 and smaller than or equal to 14.0, and
      y₂ is a number larger than or equal to 1.7 and smaller than or equal to 8.0.
III. The process or use according to embodiment I or II, wherein the at least one valuable matter containing material has been pre-treated with at least one collector.
IV The process or use according to embodiment III, wherein the at least one collector is selected from the group consisting of non-ionizing collectors and ionizing collectors.
V. The process or use according to embodiment IV, wherein the non-ionizing collector is a mineral oil.
VI. The process or use according to any one of embodiments I to V, wherein the at least one valuable matter is selected from the group consisting of Ag, Au, Pt, Pd, Rh, Ru, Ir, Os, Cu, Mo, Ni, Mn, Zn, Pb, Te, Sn, Hg, Re, V, Fe or combinations or alloys thereof.
VII. The process or use according to embodiment VI, wherein the at least one valuable matter is Mo.
VIII. The process or use according to any one of embodiments I to VII, wherein the at least one valuable matter containing material is an ore mineral.
IX. The process or use according to any one of embodiments I to VIII, wherein the at least one valuable matter is graphite.
X. The process or use according to any one of embodiments I to IX, wherein the at least one second material is at least one hydrophilic material.
XI. The process or use according to embodiment X, wherein the at least one hydrophilic material is selected form the group consisting of silicon dioxide (SiO₂), silicates, aluminosilicates, mica, and garnets (Mg, Ca, Fe^{II})₃(Al, Fe^{III})₂(SiO₄)₃.
XII. The process or use according to any one of embodiments I to XI, wherein the at least one magnetic particle is selected from the group consisting of magnetic metals and mixtures thereof, ferromagnetic alloys of magnetic metals and mixtures thereof, magnetic iron oxides, cubic ferrites of general formula M-I

M2+mFe2+1−mFe3+2O4 (M-I)
wherein M is selected from Co, Ni, Mn, Zn or mixtures thereof and m is ≤1, hexagonal ferrites and mixtures thereof.
XIII. The process or use according to any one of embodiments I to XII, wherein the at least one magnetic particle is a hydrophobized magnetic particle.
XIV. The process or use according to any one of embodiments I to XIII, wherein the at least one valuable matter containing material is present in the form of particles.
XV. The process or use according to any one of embodiments I to XIV, wherein R¹ is a branched or linear, unsubstituted C12-C18 alkyl or a branched or linear, unsubstituted C12-C18 alkenyl.
XVI. The process or use according to any one of embodiments I to XV, wherein R² is a branched or linear, unsubstituted C12-C16 alkyl.
XVII. The process or use according to any one of embodiments I to XVI, wherein x₁ is a number larger than or equal to 4.5 and smaller than or equal to 6.5.
XVIII. The process or use according to any one of embodiments I to XVII, wherein x₂ is a number larger than or equal to 4.5 and smaller than or equal to 13.0, and y₂ is a number larger than or equal to 1.8 and smaller than or equal to 7.0.
XIX. The process or use according to any one of embodiments I to XVIII, wherein the alkoxylation of R²—OH is first conducted with x₂ equivalents of ethylene oxide to obtain an ethoxylated intermediate and the ethoxylated intermediate is alkoxylated with y₂ equivalents of an alkylene oxide different from ethylene oxide, which is propylene oxide, butylene oxide or a mixture thereof.
XX. The process or use according to any one of embodiments I to XIX, wherein the alkylene oxide different from ethylene oxide is propylene oxide.
XXI. The process according to any one of embodiments I to XX, wherein in step (B) the magnetic particle and the at least one valuable matter containing material form an agglomerate.
XXII. The process according to any one of embodiments I to XXI, wherein in step (D) the content of the at least one cleavage surfactant in the dispersion II is in a range from 0.1 to 5 parts by weight based on 100 parts by weight of solids of the magnetic fraction I in the dispersion II.
XXIII. The process according to any one of embodiments I to XXII, wherein in step (D) the content of the at least one cleavage surfactant in the dispersion II is in a range from 0.01 parts to 0.5 parts by weight based on 100 parts by weight of the water in the dispersion II.
XXIV. The process according to any one of embodiments I to XXIII, wherein in step (D) the content of the solids of the magnetic fraction I in the dispersion II is in a range from 2 parts to 14 parts by weight based on 100 parts by weight of the water in the dispersion II.
XXV. The process according to any one of embodiments I to XXIV, wherein in step (E) the separation of the non-magnetic fraction II from the dispersion II comprises the separation of a magnetic fraction II from the dispersion II by applying a magnetic field, a flotation, a dense media separation, a gravity separation, a concentration with a spiral concentrator and combinations thereof.
XXVI. The process according to any one of embodiments I to XXV, further comprising step (F) that is conducted after step (E):
   (F) processing of the non-magnetic fraction II obtained in step (E) by smelting, extracting and/or wet chemical refining.

### EXAMPLES

The following examples illustrate the invention further without limiting its scope. Percentage values are percentage by weight, if not stated otherwise.

### A) Materials

All trials were performed with filtered Rhine river water from the BASF water supply system as dispersion medium.

EDTA-Na₂ was disodium ethylenediamine tetraacetate.

Shellsol® D40 (TM Shell) was purchased from Bernd Kraft GmbH. It is a C9 to C11 hydrocarbon mixture. It has a kinematic viscosity at 20° C. of 1.31 mm²/s.

Diesel is a fuel. It is a hydrocarbon mixture and has a kinematic viscosity at 20° C. of 4.98 mm²/s.

Surfactants are commercially available from BASF, Clariant or Sasol or obtained in case of alkylalkoxyethoxylates by generally known alkoxylation methods of alcohols with the required equivalents of ethylene oxide (EO) and alkylene oxides other than ethylene oxide, which is optionally followed by an end-capping.

### Alkylethoxylate

(EO=ethylene oxide, type of alcohol and equivalents of EO per one equivalent of the alcohol as starting materials of an ethoxylation reaction)

| | |
|---|---|
| S1 | C11C14 oxo-alcohol 5EO |
| S2 | C11C14 oxo-alcohol 6EO |
| S3 | C12C18 linear alcohol 5EO |
| S4 | C12C18 linear alcohol 6EO |
| S5 | iso-C13 oxo alcohol 5EO |
| S6 | iso-C13 oxo alcohol 6EO |
| S7 | iso-C13 oxo alcohol 6.5EO |
| S8 | C13C15 oxo-alcohol 5EO |
| S9 | C10 Guerbet alcohol 8EO |

### Alkylalkoxyethoxylate

(EO=ethylene oxide, PO=propylene oxide, BO=butylene oxide)
   General Synthesis Description for Firstly EO [ . . . Alcohol x₂EO+y₂ . . . ]

One equivalent of the respective alcohol was firstly ethoxylated with the stated amount of equivalents of ethylene oxide and secondly alkoxylated with the stated amount of equivalents of propylene oxide or butylene oxide in the presence of potassium hydroxide as catalyst. The reaction mixture was then neutralized with for example acetic acid. If required, an end-capping was conducted by methylation with, for example, dimethyl sulfate. The reaction mixture was then treated with water to wash off the salts generated during neutralization. The final product was then isolated from the aqueous phase by a phase separation.

General Synthesis Description for Firstly PO [ . . . Alcohol y₂PO+x₂EO]

One equivalent of the respective alcohol was firstly propoxylated with the stated amount of equivalents of propylene oxide and secondly ethoxylated with the stated amount of equivalents of ethylene oxide in the presence of potassium hydroxide as catalyst. The reaction mixture was then neutralized with, for example, acetic acid. The reaction mixture was then treated with water to wash off the salts generated during neutralization. The final product was then isolated from the aqueous phase by a phase separation.

General Synthesis Description for Randomly EO and PO [ . . . Alcohol x₂EO+y₂PO (Random)]

One equivalent of the respective alcohol was alkoxylated with a mixture of the stated amount of equivalents of ethylene oxide and the stated amounts of equivalents of propylene oxide in the presence of potassium hydroxide as catalyst. The reaction mixture was then neutralized with, for example, acetic acid. The reaction mixture was then treated with water to wash off the salts generated during neutralization. The final product was then isolated from the aqueous phase by a phase separation.

| | |
|---|---|
| S10 | C13C15 oxo-alcohol 5EO + 2BO |
| S11 | iso-C13 oxo alcohol 6EO + 3PO |
| S12 | C13C15 oxo-alcohol 12EO + 6PO (random) |

Carrier magnetites were based on ElectrOxide20 from Höganäs AB coated with a C2-silane based coating from Nano-X GmbH. The magnetites had an average particle size d₈₀ of 8 μm. The magnetite sample employed was produced by suspending the magnetite in a solution of a Nano-X silane containing dimethyl units in isopropanol, stirring the mixture for one hour and evaporation of the solvent. Before a conditioning with the Mo-concentrate feed in the load step, the magnetites were slurried in a 0.1 wt. % solution of surfactant 36 in water (14 wt. % solid content of magnetites) by a 30 mm pitch blade stirrer at 600 rpm for 15 min.

The initial Mo-concentrate was characterized by acid digestion of its solids and ICP analysis of the resulting solution. It contained 2.1 wt. % Cu, 36 wt. % Mo and 2.4 wt. % Fe. It had an insoluble content of 26.5 wt. %. It had a TOC (total organic carbon) content of 0.8 wt. % and showed a drying loss of 5 wt. %.

The modal mineralogy of the initial Mo-concentrate was characterized by MLA to comprise 49 wt. % molybdenite, 9 wt. % pyrophyllite, 5 wt. % kaolinite, 3 wt. % quartz, 1 wt. % chalcopyrite, 0.5 wt. % illite, 0.5 wt. % pyrite and the rest being different Mo-containing clay phases. The initial Mo-concentrate was in the form of particles with an average particle size d₈₀ of 40 μm and particle size distributions d₅₀ of 17.4 wt. % and d₈₀ 39.8 wt. %.

### B) Methods

The elemental composition of the initial Mo-concentrate was measured by acid digestion of the solid and ICP analysis of the resulting solution.

The insoluble content of the initial Mo-concentrate was measured according to the following procedure: A sample of 1 g materials was treated with a mixture of 10 mL conc. nitric acid and 3 mL conc. perchloric acid at 150° C. until the liquid was completely evaporated. The residue was suspended in 10 mL conc. hydrochloric acid at 150° C., filtered and the filter residue was washed 3 times with water. The remaining filter residue was calcined at 600° C. The mass of this residue represented the insoluble content.

TOC (total organic carbon) of the initial Mo-concentrate was measured by burning the carbon in a stream of air and analyzing the resulting water and carbon dioxide.

Drying loss was determined by a Mettler Toledo HB43-S Halogen moisture analyzer at 130° C.

Particle size distributions were measured by laser diffraction employing a Malvern Mastersizer 2000.

The final slurries obtained from the magnetic separation were filtered and dried in vacuo at 90° C. Before analyses the dry materials are homogenized in a Retsch MM400 oscillating mill (25 mL ZrO₂ lined beaker with one 15 mm ZrO₂-ball)

Elemental analyses of the final slurries were performed using a mobile RFA analyzer (Olympus Innov-X) calibrated by data from ICP-analysis of materials with similar matrix compositions as the different sample fractions, i.e. feeds, magnetic and non-magnetic fractions.

In all experiments, the calculation of the recovery Rᵢ was given as distribution of Mo and Cu calculated from the weights of Cu and Mo recovered in the magnetic (m_{c,i}) and non-magnetic fractions (m_{T,i}):

$${R}_{i} = {m}_{C , i} / ( {m}_{C , i} ) + {m}_{T , i} ) with i = Cu , Mo$$

This calculation method was chosen as it minimizes errors from feed sample taking and volatile contents of the feed material which needed not to be considered here. The mass balance of each experiment was checked as well and it was close to 100%.

In the case of unload experiments, the recovery of Mo in the non-magnetic fraction was also named unload efficiency.

### C) Load/Unload Examples

### C-1: Load/Unload Examples of a Mo-Concentrate at 5.6 Parts Solids Per 100 Parts Water

For loading, 150 g of initial Mo-concentrate were dispersed in 450 g of water and stirred with an UltraTurrax T50 mixer at 6000 rpm. The slurry was filtered to obtain a wet filter cake with a drying loss of 78.6% (at 130° C.). A quantity of this wet material corresponding to 120 g dry solid (152.7 g) was placed in a 1000 ml beaker equipped with baffles and dispersed with additional 327.3 g water giving a slurry of 120 g solids in 360 g water, i.e. a solid content of 25 wt. %. 9 mg of EDTA-Na2 salt were added to this slurry (200 mmol/kg) and the slurry was mixed for 5 min with an UltraTurrax T50 mixer at 6000 rpm. After this, 3 g diesel were added and mixed for additional 2 min by the UltraTurrax T50 at 6000 rpm (the slurry is cooled with an ice bath to avoid heating and evaporation of Shellsol). To this mixture, 3 g of pre-dispersed magnetite (21.4 g of a suspension with 14 parts magnetite particles, 0.086 parts Surfactant 36 and 85.914 parts water) was added and mixed with a 45 mm pitch blade stirrer for 15 min at 1000 rpm. This slurry was fed to the Eriez L4 lab-scale separator equipped with a 4×2 wedged wire matrix with a flow of 6 L/h at a magnetic field of 0.7 T. The separation was conducted in 4 steps to avoid overloading of the matrix. Between each step the matrix was taken outside the magnetic field and flushed with water. The magnetic fractions were unified filtered and employed as aliquots of the wet filter cake in the unload screening tests within one day.

For unloading, 28 g (dry mass) of the load magnetic fraction were dispersed in 500 g water as wet filter cake (solids to water: 5.6 parts solids to 100 parts water) in a 2 L baffled beaker and stirred with a 70 mm pitch blade stirrer at 300 rpm. To this slurry, 0.28 g of a surfactant as described in table C-1-1 were added (surfactant to solids: 1 parts surfactant to 100 parts solids, surfactant to water: 0.056 parts surfactant to 100 parts water). This mixture was stirred for 10 min at 300 rpm. The slurry was then directly pumped to a magnetic separator under continuous stirring, finely residual feed material was flushed to the feed pump by some water. The separation was done in a magnetic separator as described in WO 2014/068142 A1 comprising a L-shaped glass tube with an inner diameter of 10 mm (the numbers in brackets resemble the numbers in claims 1 and 5 of WO 2014/068142 A1). The L-shape glass tube consisted of a first straight vertical tube (1) and an elbow pipe ending in a first straight tube perpendicular to the first vertical straight tube. The elbow tube had a radius of curvature of approx. 80 mm. At the entrance of the passage from the vertical tube to the elbow a second vertical tube extending the first vertical tube was mounted allowing a fluid flow from the entrance of the first vertical tube into the second vertical tube and into the elbow and thus, into the first perpendicular tube. Along the L-shaped tube consisting of the first vertical tube, the elbow and the first perpendicular tube, a conveying belt (7) was mounted in a triangular arrangement in the inner part of the L-shape by three reels mounted at the top of the first perpendicular tube in the curvature of the elbow and at the end of the first perpendicular tube. On the conveying belt yoke-shaped magnets were arranged such that the L-shaped tube was encircled by the yokes. An electric motor moved the conveying belt and thus the yoke magnets along the L-shaped tube. At the outer part of the L-shape tube at the first perpendicular tube another third vertical tube (3) was mounted allowing a fluid flow into the first perpendicular tube. This separator was operated in a way that a slurry was fed to the top of the first vertical tube (2) by a peristaltic pump. At the end of the first perpendicular tube (5) another peristaltic pump generated a fluid flow to the end of the first perpendicular tube. Via the third perpendicular tube (3) another fluid flow was fed into the first perpendicular tube. Thus, into the separator were fed the slurry feed flow from the top of the first vertical tube, the flush-water flow fed to the third vertical tube and the separator left a slurry flow via the second vertical tube (4) and a slurry flow via the first perpendicular tube. The settings of the pumps were such that the sum of the feed flows equaled the sum of the exiting fluid flows. The conveying belt with the yoke-magnets was moved in a direction parallel to the fluid flow in the first vertical tube. Any magnetic particle was attracted to the inner wall of the L-shaped tube, where it was moved by the moving magnets along the elbow into the first perpendicular tube. The flush-water flow to the third vertical tube was set high enough to impede entering non-magnetic particles from the slurry in the first vertical tube into the first perpendicular tube.” For the examples, the flow settings were: Feed slurry flow into the first vertical tube of 24 L/h and the magnetic chain was rotated in co-current mode at 10 cm/sec. Flush water flow to the third vertical tube was pumped at a flow of 12 L/h and the magnetic fraction was pumped out with a flow of 7 L/h. From these settings, the flow of the slurry leaving the second vertical tube was calculated to be 29 L/h. This latter flow contained the non-magnetic particles of the feed flow. The magnetic fraction and the non-magnetic fraction were separately collected as final slurries. The obtained unload Mo recovery values, which were contained in the non-magnetic fraction, are depicted in Table C-1-1.

TABLE C-1-1

| | surfac- | | unload Mo |
|---|---|---|---|
| example No. | tant | chemical nature of surfactant | recovery^{c)} |
| C-1-1-1 ^{b)} | S1 | C11C14 oxo-alcohol 5EO | 99.03 |
| C-1-1-2 ^{b)} | S2 | C11C14 oxo-alcohol 6EO | 99 |
| C-1-1-3 ^{b)} | S3 | C12C18 linear alcohol 5EO | 99.08 |
| C-1-1-4 ^{b)} | S4 | C12C18 linear alcohol 6EO | 99.5 |
| C-1-1-5 ^{b)} | S5 | iso-C13 oxo alcohol 5EO | 99.39 |
| C-1-1-6 ^{b)} | S6 | iso-C13 oxo alcohol 6EO | 99.63 |
| C-1-1-7 ^{b)} | S7 | iso-C13 oxo alcohol 6.5EO | 98.39 |
| C-1-1-8 ^{b)} | S8 | C13C15 oxo-alcohol 5EO | 99.77 |
| C-1-1-9 ^{a)} | S9 | C10 Guerbet alcohol 8EO | 86.33 |
| C-1-1-10 ^{b)} | S10 | C13C15 oxo-alcohol 5EO + 2BO | 99.3 |
| C-1-1-11 ^{b)} | S11 | iso-C13 oxo alcohol 6EO + 3PO | 99.07 |
| C-1-1-12 ^{b)} | S12 | C13C15 oxo-alcohol 12EO + 6PO | 99.27 |
| | | (random) | |

^{a)} out of scope
^{b)} according to invention
^{c)}recovered Mo weight content in the non-magnetic fraction at the end of the unloading and based on the Mo weight content of the load magnetic fraction at the start of the unloading

The results in table C-1-1 show that high unload efficiencies differ depending on the chemical nature of the surfactant. The efficiency of the Mo unload depends on the chemical nature of the surfactant.

Inspection of the chemical nature of the best surfactants in table C-1-1 shows that these are alkylethoxylates based on alcohols with 11 to 18 carbon atoms and an ethoxylation with 5, 6 or 6.5 equivalents of ethylene oxide or alkylalkoxylethoxylates based on alcohols with 13 to 15 carbon atoms and an alkoxylation with 5 to 12 equivalents of ethylene oxide and 2 to 6 equivalents of propylene oxide or butylene oxide.

1.-17. (canceled)

18. A process for separation of at least one valuable matter containing material from a dispersion I comprising said at least one valuable matter containing material and at least one second material, wherein the process comprises the steps of:
(A) providing the dispersion I comprising the at least one valuable matter containing material and the at least one second material;
(B) contacting the dispersion I of step (A) with at least one magnetic particle to obtain a contacted dispersion I;
(C) separating a magnetic fraction I from the contacted dispersion I by applying a magnetic field, wherein the magnetic fraction I comprises the at least one magnetic particle and the at least one valuable matter containing material;
(D) dispersing the magnetic fraction I in at least one dispersion medium II, which contains water and at least one cleavage surfactant, to obtain a dispersion II; and
(E) separating a non-magnetic fraction II from the dispersion II, wherein the non-magnetic fraction II comprises at least one valuable matter containing material;
wherein the at least one cleavage surfactant is selected from the group consisting of
(i) alkylethoxylates, which are obtainable by an ethoxylation of R¹—OH with x₁ equivalents of ethylene oxide based on one equivalent R¹—OH, wherein
R¹ is a branched or linear, unsubstituted C11-C18 alkyl or branched or linear, unsubstituted C11-C18 alkenyl, and
x₁ is a number larger than or equal to 4.0 and smaller than or equal to 6.5; and
(ii) alkylalkoxyethoxylates, which are obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, wherein
R² is a branched or linear, unsubstituted C12-C18 alkyl or branched or linear, unsubstituted C12-C18 alkenyl,
x₂ is a number larger than or equal to 4.0 and smaller than or equal to 14.0, and
y₂ is a number larger than or equal to 1.7 and smaller than or equal to 8.0.

19. A method for cleaving agglomerates comprising magnetic particles and at least one valuable matter containing material to obtain magnetic particles and at least one valuable matter containing material separately, wherein the method comprises at least one cleavage surfactant selected from the group consisting of
(i) alkylethoxylates, which are obtainable by an ethoxylation of R¹—OH with x₁ equivalents of ethylene oxide based on one equivalent R¹—OH, wherein
R¹ is a branched or linear, unsubstituted C11-C18 alkyl or branched or linear, unsubstituted C11-C18 alkenyl, and
x₁ is a number larger than or equal to 4.0 and smaller than or equal to 6.5; and
(ii) alkylalkoxyethoxylates, which are obtainable by an alkoxylation of R²—OH with x₂ equivalents of ethylene oxide and y₂ equivalents of an alkylene oxide different from ethylene oxide, which is propylene oxide, butylene oxide or a mixture thereof, based on one equivalent R²—OH, wherein
R² is a branched or linear, unsubstituted C12-C18 alkyl or branched or linear, unsubstituted C12-C18 alkenyl,
x₂ is a number larger than or equal to 4.0 and smaller than or equal to 14.0, and
y₂ is a number larger than or equal to 1.7 and smaller than or equal to 8.0.

20. The process according to claim 18, wherein the at least one valuable matter containing material has been pre-treated with at least one collector.

21. The process according to claim 20, wherein the at least one collector is selected from the group consisting of non-ionizing collectors and ionizing collectors.

22. The process according to claim 18, wherein the at least one valuable matter is selected from the group consisting of Ag, Au, Pt, Pd, Rh, Ru, Ir, Os, Cu, Mo, Ni, Mn, Zn, Pb, Te, Sn, Hg, Re, V, Fe and combinations or alloys thereof.

23. The process according to 18, wherein the at least one valuable matter is Mo.

24. The process according to claim 18, wherein the at least one second material is at least one hydrophilic material.

25. The process according to claim 18, wherein the at least one magnetic particle is selected from the group consisting of magnetic metals and mixtures thereof, ferromagnetic alloys of magnetic metals and mixtures thereof, magnetic iron oxides, cubic ferrites of general formula M-I
M²⁺ₘFe²⁺₁₋ₘFe³⁺₂O₄ (M-I)
wherein M is selected from Co, Ni, Mn, Zn and mixtures thereof and m is ≤1, hexagonal ferrites and mixtures thereof.

26. The process according to claim 18, wherein the at least one magnetic particle is a hydrophobized magnetic particle.

27. The process according to claim 18, wherein R¹ is a branched or linear, unsubstituted C12-C18 alkyl or a branched or linear, unsubstituted C12-C18 alkenyl.

28. The process according to claim 18, wherein R² is a branched or linear, unsubstituted C12-C16 alkyl.

29. The process according to claim 18, wherein x₁ is a number larger than or equal to 4.5 and smaller than or equal to 6.5.

30. The process according to claim 18, wherein x₂ is a number larger than or equal to 4.5 and smaller than or equal to 13.0, and y₂ is a number larger than or equal to 1.8 and smaller than or equal to 7.0.

31. The process according to claim 18, wherein the alkoxylation of R²—OH is first conducted with x₂ equivalents of ethylene oxide to obtain an ethoxylated intermediate and the ethoxylated intermediate is alkoxylated with y₂ equivalents of an alkylene oxide different from ethylene oxide, which is propylene oxide, butylene oxide or a mixture thereof.

32. The process according to claim 18, wherein in step (D) the content of the at least one cleavage surfactant in the dispersion II is in a range from 0.1 to 5 parts by weight based on 100 parts by weight of solids of the magnetic fraction I in the dispersion II.

33. The process according to claim 18, wherein in step (D) the content of the at least one cleavage surfactant in the dispersion II is in a range from 0.01 parts to 0.5 parts by weight based on 100 parts by weight of the water in the dispersion II.

34. The process according to claim 18, wherein in step (E) the separation of the non-magnetic fraction II from the dispersion II comprises the separation of a magnetic fraction II from the dispersion II by applying a magnetic field, a flotation, a dense media separation, a gravity separation, a concentration with a spiral concentrator and combinations thereof.
